(19) United States
(12) Patent Application Publication
(10) Pub. No.: US 2016/0124272 A1
(43) Pub. Date: May 5, 2016

(54) LIQUID CRYSTAL DISPLAY DEVICE AND MANUFACTURING METHOD THEREOF

(71) Applicant: Samsung Display Co., Ltd., Yongin-si (KR)

(72) Inventors: Young-Gu KIM, Hwaseong-si (KR); Jin-Soo JUNG, Hwaseong-si (KR); Hak-Sun CHANG, Yongin-si (KR)

(21) Appl. No.: 14/991,521

(22) Filed: Jan. 8, 2016

Related U.S. Application Data
(62) Division of application No. 13/243,861, filed on Sep. 23, 2011.

(30) Foreign Application Priority Data
Mar. 16, 2011 (KR) 10-2011-0023335

(51) Int. Cl. G02F 1/1337; G02F 1/1341

(52) U.S. Cl. CPC G02F 1/133788; G02F 1/1341; G02F 1/133753; G02F 2001/133757

(57) ABSTRACT

In summary, when the alignment layer aligns the adjacent liquid crystal molecules while producing the pretilt, the present invention basically forms a different pretilt of the alignment layer of the upper substrate or the alignment layer of the lower substrate, or basically forms a different pretilt of the alignment layer of the high gray subpixel and the alignment layer of the low gray subpixel in one pixel, and as a result, the visibility is improved in the sides (the upper side or the right and left sides).

### CROSS-REFERENCE TO RELATED APPLICATION

This application is a Divisional of U.S. patent application Ser. No. 13/243,861, filed on Sep. 23, 2011, and claims priority to and the benefit of Korean Patent Application No. 10-2011-0023335, filed on Mar. 16, 2011, both of which are incorporated herein by reference for all purposes as if fully set forth herein.

### BACKGROUND OF THE INVENTION

1. Field of the Invention

Exemplary embodiments of the present invention relates to a liquid crystal display and a manufacturing method thereof, more particularly, to a vertical alignment (VA) mode liquid crystal display and a manufacturing method thereof.

2. Description of the Background

A liquid crystal display (LCD) device has been adopted as one of the commonly used flat panel displays. In the LCD device, typically a voltage is applied to the field generating electrodes to generate an electric field on the liquid crystal layer to thereby determine alignment of liquid crystal molecules of the liquid crystal layer and to control polarization of incident light, thereby allowing display of images.

Among the liquid crystal displays, a vertical alignment (VA) mode liquid crystal display provides users with high contrast ratio and wide reference viewing angle.

In the vertical alignment (VA) mode LCD, wide reference viewing angle can be realized by forming a plurality of domains including liquid crystal of different alignment directions in one pixel. As one example of forming the plurality of domains in one pixel, there is a method of forming cutouts in the field generating electrodes. In this method, the plurality of domains may be formed by aligning the liquid crystal molecules vertically with respect to a fringe field generated between the edges of the cutout and the field generating electrodes facing the edges.

However, in this structure, manufacturers are challenged as the aperture ratio is decreased, and the liquid crystal molecules disposed close to the cutouts may be aligned vertical to the fringe field, but the liquid crystal molecules far from the cutouts generate random motion such that the response speed is slow and a reversed direction domain is formed, thereby generating temporary afterimages.

As another means for forming the plurality of domains in one pixel, there is a photo-alignment method in which the alignment direction of the liquid crystal molecules and the alignment angle are controlled by irradiating light on the alignment layer. In the photo-alignment method, it is not necessary to form the cutouts in the field generating electrodes such that the aperture ratio may be increased and the response of the liquid crystal may be improved by a pretilt angle generated under the photo-alignment.

Unfortunately, the liquid crystal display of the vertical alignment (VA) mode has poor side visibility compared with front visibility such that one pixel may be need to be divided into two subpixels and different voltages are required to apply to the subpixels to solve this problem.

Particularly, when several people frequently watch a large-sized display device such as a television, several people watch the display device from the right and left sides such that the side visibility is an important factor to determine a display quality.

Therefore, there is a need to improve side visibility of a liquid crystal display.

The above information disclosed in this Background section is only for enhancement of understanding of the background of the invention and therefore it may contain information that does not form the prior art that is already known in this country to a person of ordinary skill in the art.

### SUMMARY OF THE INVENTION

These and other needs are addressed by the present invention, in which exemplary embodiments of the present invention provides a side visibility improvement, and a manufacturing method thereof of a liquid crystal display.

Exemplary embodiments of the present invention disclose a liquid crystal display. The display includes a lower panel including a lower substrate and a lower alignment layer disposed on the lower substrate. The display also includes an upper panel including an upper substrate and an upper alignment layer disposed on the upper substrate. And a vertical alignment (VA) mode liquid crystal layer is disposed between the lower panel and the upper panel and having a plurality of liquid crystal molecules. Liquid crystal molecules adjacent to the lower alignment layer are arranged with a first pretilt, and liquid crystal molecules adjacent to the upper alignment layer are arranged with a second pretilt. And the magnitude of the first pretilt and the magnitude of the second pretilt are different from each other.

Exemplary embodiments of the present invention disclose a liquid crystal display. The display includes a lower panel including a lower substrate and a lower alignment layer disposed on the lower substrate. The display also includes an upper panel including an upper substrate and an upper alignment layer disposed on the upper substrate. The display includes a vertical alignment (VA) mode liquid crystal layer which is inserted between the lower panel and the upper panel and having a plurality of liquid crystal molecules. The magnitude of the first alignment force aligning the liquid crystal molecule adjacent to the lower alignment layer and the magnitude of the second alignment force aligning the liquid crystal molecule adjacent to the upper alignment layer are different from each other.

Exemplary embodiments of the present invention disclose a liquid crystal display. The display includes a lower panel including a lower substrate and a lower alignment layer formed on the lower substrate. The display includes an upper panel including an upper substrate and an upper alignment layer formed on the upper substrate. The display includes a vertical alignment (VA) mode liquid crystal layer which is disposed between the lower panel and the upper panel and having a plurality of liquid crystal molecules, wherein a pixel comprises a first subpixel and a second subpixel. And a liquid crystal molecule adjacent to one alignment layer of the lower alignment layer or the upper alignment layer of the first subpixel is aligned with a first pretilt. And a liquid crystal molecule adjacent to one alignment layer of the lower alignment layer or the upper alignment layer of the first subpixel is aligned with a second pretilt, and the magnitudes of the first pretilt and the second pretilt are different from each other.

Exemplary embodiments of the present invention disclose a method for manufacturing a liquid crystal display. The method includes disposing a lower alignment layer on a lower substrate. The method includes disposing an upper alignment layer on an upper substrate. The method also includes combining the upper substrate and the lower substrate, and inserting a liquid crystal layer therebetween, wherein a first irradiation amount of which ultraviolet rays are irradiated to the lower alignment layer or the upper alignment layer in a first direction and a second irradiation amount of which ultraviolet rays are irradiated to the lower alignment layer or the upper alignment layer in a second direction perpendicular to the first direction are different.

Exemplary embodiments of the present invention disclose an apparatus. The apparatus includes a panel comprising a first substrate and a second substrate and an alignment layer disposed on the respective substrates. The apparatus also includes a vertical alignment mode layer interposed between the first substrate and the second substrate, wherein the alignment layer is configured to form a different pretilt with respect to a pixel corresponding to each of the first substrate and the second substrate.

Exemplary embodiments of the present invention disclose a method. The method includes arranging an alignment layer corresponding to a substrate of a liquid crystal display, the substrate comprising a first substrate and a second substrate. The method also includes disposing a liquid crystal layer between the first substrate and the second substrate, wherein the alignment layer is configured to form a different pretilt angle associated with the alignment layer by adjusting a direction of an irradiation with respect to the first substrate and the second substrate.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a layout view of a liquid crystal display according to exemplary embodiments of the present invention, showing an alignment direction of liquid crystal molecules.

FIG. 2 is a diagram to explain a method of forming the exemplary embodiment of FIG. 1.

FIG. 3 to FIG. 6 are diagrams showing an arrangement of liquid crystal molecules of a portion III of FIG. 2.

FIG. 7 is a diagram showing a method of forming the exemplary embodiment of FIG. 1 as a different method from that of FIG. 2.

FIG. 8 is a graph showing a characteristic of liquid crystal that is arranged under two exposures in exemplary embodiments of the present invention.

FIG. 9 and FIG. 10 are layout views showing a manufacturing method of a liquid crystal display according to exemplary embodiments of the present invention.

FIG. 11 to FIG. 13 are graphs and a table showing a pretilt value according to an irradiation amount of ultraviolet rays in exemplary embodiments of the present invention.

FIG. 14 is a graph showing an alignment angel of a liquid crystal according to a pretilt difference of lower and upper panels in exemplary embodiments of the present invention.

FIG. 15 is a graph of a change of a visibility index (GDI) of a side according to an alignment angel of a liquid crystal in exemplary embodiments of the present invention.

FIG. 16 and FIG. 17 are a table and a graph showing a change of a pretilt according to thickness of an alignment layer in exemplary embodiments of the present invention.

FIG. 18 is a graph showing a change of a pretilt according to flatness of a layer under an alignment layer in exemplary embodiments of the present invention.

FIG. 19 is an enlarged photograph of a surface of each lower layer of FIG. 18.

FIG. 20 is a graph showing a change of a pretilt according to a temperature of baking an alignment layer in exemplary embodiments of the present invention.

FIG. 21 is a table showing comparative data of a side visibility index (GDI) in exemplary embodiments of the present invention.

FIG. 22 is a graph showing a gamma curve of a high gray subpixel and a low gray subpixel in exemplary embodiments of the present invention.

FIG. 23 is a view showing a manufacturing method of a liquid crystal display according to exemplary embodiments of the present invention.

FIG. 24 to FIG. 27 are cross-sectional views showing a method of FIG. 23 in detail.

FIG. 28 is a view showing a manufacturing method of a liquid crystal display according to exemplary embodiments of the present invention.

FIG. 29 is a view showing a portion of an inkjet sprayer used to manufacture the liquid crystal display of FIG. 28.

FIG. 30 is a table showing a relationship of thickness and pretilt of an alignment layer according to FIG. 28.

FIG. 31 is a view showing a manufacturing method of a liquid crystal display according to exemplary embodiments of the present invention.

FIG. 32 is a view showing a portion of an inkjet sprayer used to manufacture the liquid crystal display of FIG. 31.

FIG. 33 to FIG. 35 are views showing a manufacturing method of a liquid crystal display according to exemplary embodiments of the present invention.

FIG. 36 shows a layout of a lower panel used in exemplary embodiments of the present invention.

FIG. 37 is a circuit diagram of a pixel structure used in exemplary embodiments of the present invention.

FIG. 38 is a flowchart of process for providing different pretilt angle associated an alignment layer for adjusting a direction of an irradiation according to exemplary embodiments of the present invention.

FIG. 39 is a diagram showing alignment material, according to exemplary embodiments of the present invention.

### DETAILED DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In the drawings, thickness of layers, films, panels, and regions may be exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

By way of example, a pretilt represents an angle of liquid crystal molecules close to an alignment layer that may obliquely be arranged with respect to the alignment layer, and an alignment direction means a direction that the liquid crystal molecules can be arranged in average in one domain and represents an azimuth in a surface of an upper or lower substrate. Also, an alignment force is a force for the alignment layer to align the liquid crystal molecule with the pretilt. Finally, a display panel and a substrate may be used as divided items. The display panel may include the substrate and a sum of a plurality of layers may be formed on the substrate, and the substrate can be an insulation substrate itself.

For example, the present invention is an invention in which one pixel is divided into a plurality of domains in the vertical alignment (VA) mode liquid crystal display, and the liquid crystal molecules are aligned into different alignment directions for the domain through photo-alignment, thereby improving the side visibility. Particularly, the alignment direction of the liquid crystal is perpendicular or parallel, or does not form 45 degrees for one edge (a long edge or a short edge) of the upper or lower substrate of the liquid crystal display, if liquid crystal alignment directions are connected to each other in four adjacent domains in one pixel, thereby forming a rhombus, and an inner angle of the rhombus in the present invention has an obtuse angle or an acute angle, not including 90 degree.

Also, in the present invention, the alignment force of the upper panel and the alignment force of the lower panel have different directions and different magnitudes, thereby improving the side visibility. Here, the side visibility may be left/right side visibility or upper side visibility.

Now, a liquid crystal display according to exemplary embodiments of the present invention will be described with reference to accompanying drawings.

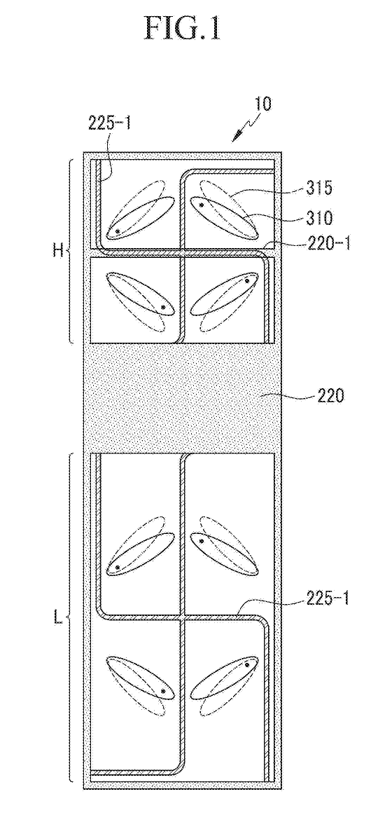

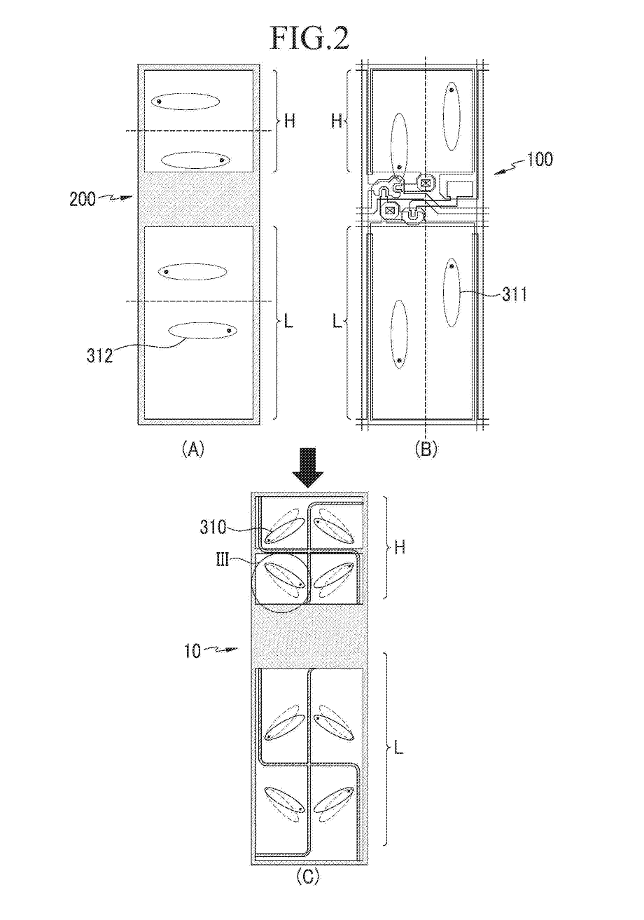

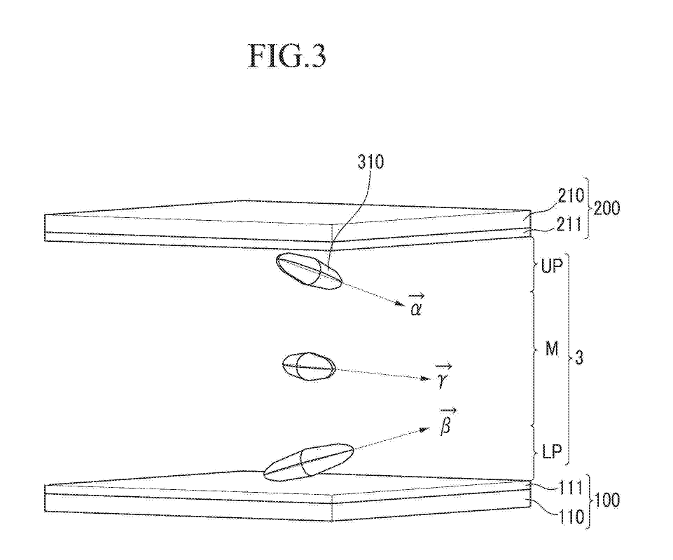

FIG. 1 is a layout view of a liquid crystal display according to exemplary embodiments of the present invention, showing an alignment direction of liquid crystal molecules, FIG. 2 is a view to explain a method of forming the exemplary embodiment of FIG. 1, and FIG. 3 to FIG. 6 are views showing an arrangement of liquid crystal molecules of a portion III of FIG. 2.

FIG. 1 is a layout view of one pixel 10 in the liquid crystal display according to exemplary embodiments of the present invention, showing the alignment direction of liquid crystal molecules 310.

Firstly, in the liquid crystal display according to exemplary embodiments of the present invention, the pixel 10 include a high gray subpixel H positioned upward and a low gray subpixel L disposed downward.

A space between the high gray subpixel H (referred to as the first subpixel) and the low gray subpixel L (referred to as the second subpixel) and the external thereof are covered by a light blocking member 220. The light blocking member 220 according to exemplary embodiments of the present invention is formed in the upper panel, and includes a portion 220-1 dividing the high gray subpixel up and down in two parts.

The high gray subpixel H and the low gray subpixel L are divided into four domains and are disposed with a 2×2 structure. Also, the liquid crystal layer is aligned into the different alignment directions in four adjacent domains. The alignment directions of the liquid crystal layer will be described with reference to FIG. 3 to FIG. 7.

The liquid crystal alignment directions are connected to each other in four adjacent domains with the high gray subpixel H and the low gray subpixel L, thereby forming a rhombus, and the rhombus of the present invention has an obtuse angle or an acute angle not having a 90 degree angle.

In the liquid crystal display, for example, the liquid crystal alignment direction of one domain forms an angle of less than 45 degrees for the direction of one edge (the long edge or the short edge, hereafter it is described with reference to the long edge) of the upper or lower substrate. In FIG. 1, dots are stamped to the liquid crystal molecules 310, however the dots do not actually exist in the liquid crystal molecules 310, but apparently and arbitrary represent head portions of each liquid crystal molecule 310. Also, in FIG. 1, imaginary liquid crystal molecules 315 are shown by dotted lines, and the imaginary liquid crystal molecules 315 are liquid crystal molecules 315 forming an angle of 45 degrees for the long edge direction of the substrate. Therefore, FIG. 1 apparently shows the liquid crystal molecules 310 forming the different angles for the long edge direction of the substrate (hereinafter, simply referred to as a long edge direction), not including 45 degree.

If an arrow (it accords with the alignment direction) that is extended from a tail portion to the head portion of the liquid crystal molecules 310 in each domain of the high gray subpixel H is drawn, a rhombus having a longer component of the long edge direction than the short edge direction is drawn, and has a shape that is rotated in a counterclockwise direction. This is the same in the low gray subpixel L. As an example, it may be rotated in the clockwise direction.

As described above, the head portion of the liquid crystal molecules 310 in each domain is toward the long edge direction such that the viewing visibility at the sides (the right and left sides) of the long edge direction is improved. That is, it may be confirmed that the liquid crystal molecules 310 of each domain are further inclined in the long edge direction than the imaginary liquid crystal molecules 315, and as a result the display device has a merit that the right and left side visibility can be improved.

On the other hand, different from FIG. 1, the liquid crystal molecules 310 of each domain may be further inclined in the vertical direction than the imaginary liquid crystal molecules 315. The up and down side visibility of the liquid crystal display of this case can be improved, and this display device can be used in the case of viewing the display device in the up and down sides rather than the right and left sides.

In general, a large-sized liquid crystal display such as the television is frequently watched by several viewers in the right and left sides such that it will be described focusing on right and left side visibility.

Meanwhile, in the exemplary embodiment of FIG. 1, an additional light blocking member 225-1 may be formed to cover texture generated in the boundary between the domains. The additional light blocking member 225-1 may be formed in the upper panel or the lower panel.

Next, one of various exemplary embodiments of manufacturing the liquid crystal display like FIG. 1 will be described with reference to FIG. 2.

For example, in the liquid crystal display, alignment layers (not shown in the layout view) formed in the upper panel 200 and the lower panel 100 have different alignment forces such that there is a characteristic that the alignment direction of the liquid crystal molecule in each domain does not form an angle of 45 degrees with respect to the long edge direction of the substrate.

For this purpose, in the exemplary embodiment of FIG. 2, the upper panel 200 is light-aligned in the long edge direction, and the lower panel 100 is light-aligned in the short edge direction.

Firstly, the photo-alignment of the upper panel 200 will be described.

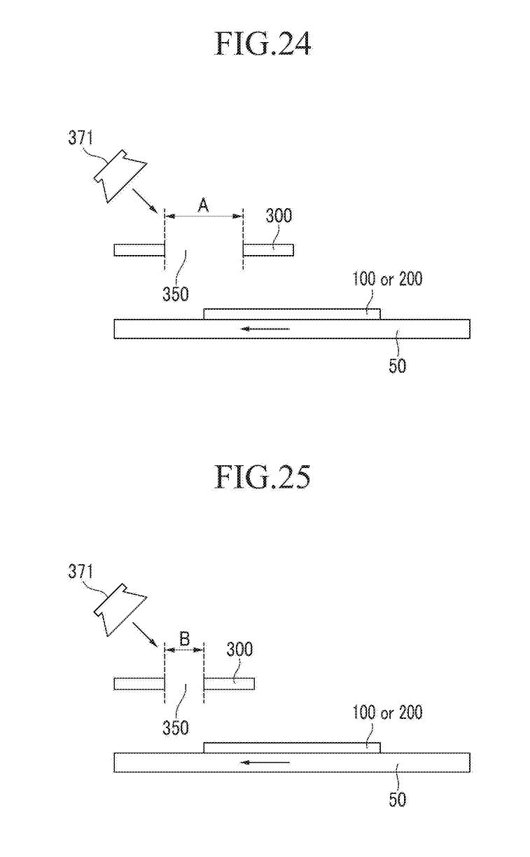

As shown in FIG. 2(A), the high gray subpixel H and the low gray subpixel L of the upper panel 200 are respectively divided up and down into two parts such that the alignment layer of the upper region is light-aligned for the head portion of the liquid crystal molecule 310 to be toward the left side, and the alignment layer of the lower region is light-aligned for the head portion of the liquid crystal molecule 310 to be toward the right side. The lower region is covered by a mask during the photo-alignment of the upper region and the upper region is covered by a mask under the photo-alignment of the lower region. In the photo-alignment, light such as ultraviolet rays is irradiated to the alignment layer of the upper panel 200 at a predetermined angle such that the liquid crystal molecule 310 is arranged in the corresponding direction (referring to FIG. 24). As a result, the liquid crystal molecule 310 is pretilted in the alignment layer of the upper panel 200, and the force to pretilt the liquid crystal molecule 310 by the alignment layer is referred to as an alignment force.

FIG. 2(A) is the layout view such that the alignment layer is not shown. Also, the liquid crystal molecule 310 aligned by the alignment layer of the upper panel 200 is shown and is reflected to the upper panel 200 such that it is simply shown that the liquid crystal molecule 310 is only aligned in the long edge direction, however the liquid crystal molecule 310 is actually pretilted while forming a predetermined angle from the upper panel 200. The pretilt and the alignment direction of the liquid crystal molecule 310 will be described with reference to FIG. 3 to FIG. 6.

On the other hand, FIG. 2(B) shows the photo-alignment of the lower panel 100. The high gray subpixel H and the low gray subpixel L of the lower panel 100 are respectively divided left and right into two parts such that the alignment layer of the left region is light-aligned for the head portion of the liquid crystal molecule 310 to be toward the lower side and the alignment layer of the right region is light-aligned for the head portion of the liquid crystal molecule 310 to be toward the upper side. The left region is covered by a mask under the photo-alignment of the right region and the right region is covered by a mask under the photo-alignment of the left region. FIG. 2(B) is the layout view such that the alignment layer is not shown. Also, FIG. 2(B) shows the liquid crystal molecule 310 that is reflected to the lower panel 100 such that it is simply shown that the liquid crystal molecule 310 is only aligned in the up and down direction, however the liquid crystal molecule 310 is actually pretilted while forming a predetermined angle from the lower panel 100. This will be described with reference to FIG. 3 to FIG. 6.

As described above, if the upper panel 200 and the lower panel 100 including the light-aligned alignment layers are combined and the liquid crystal layer is inserted therebetween, the liquid crystal molecules 310 in each domain are aligned in the alignment directions as shown in FIG. 2(C).

According to an exemplary embodiment of FIG. 2, the alignment force of the alignment layer of the upper panel 200 is larger than the alignment force of the alignment layer of the lower panel 100. As a result, as shown in FIG. 2(C), the liquid crystal molecule has an angle of less than 45 degrees (shown by the dotted line) with respect to the long edge direction.

Next, the pretilt and the alignment direction of the liquid crystal molecule will be described based on the domain III of FIG. 2 with reference to FIG. 3 to FIG. 6.

FIG. 2 is a view to explain a method forming the exemplary embodiment of FIG. 1, and FIG. 3 to FIG. 6 are views showing an arrangement of liquid crystal molecules of a portion III of FIG. 2.

For example, FIG. 3 shows the upper panel 200 including the upper substrate 210 and an upper alignment layer 211, and the lower panel 200 including a lower substrate 110 and a lower alignment layer 111. The upper panel 200 and the lower panel 100 may include different constituent elements in addition to the substrate and the alignment layer, however only basic constituent elements are included.

By way of example, the liquid crystal layer 3 of the domain III may be divided into three portions. The three portions include, for example, an upper pretilt region UP, a lower pretilt region LP, and a middle region M.

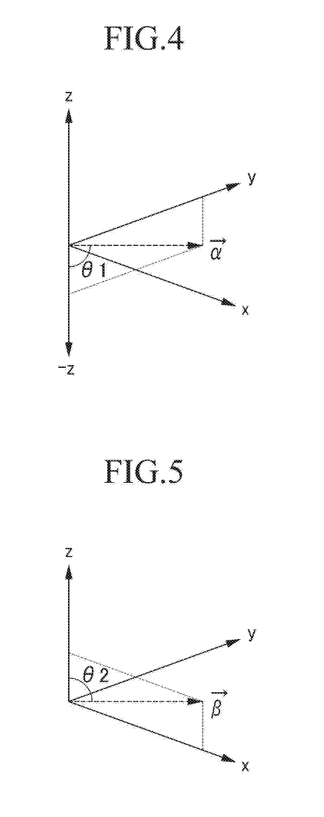

The upper pretilt region UP is a region where the liquid crystal molecule 310 positioned at a region close to the upper alignment layer 211 among the liquid crystal layer 3 is pretilted by the alignment force of the upper alignment layer 211. The long axis of the liquid crystal molecule 310 of the upper pretilt region UP is arranged in an alpha vector direction, and this is shown in FIG. 4. Here, the z axis direction as a direction from the lower substrate 110 toward the upper substrate 210 is perpendicular to the surface of the substrates 110 and 210, the x axis direction is the short edge direction of the substrates 110 and 210, and the y axis direction is the long edge direction of the substrates 110 and 210. The alpha vector direction in FIG. 4 forms the angle θ1 from the −z axis while being parallel to the long edge direction of the substrates 110 and 210. Here, the angle θ1 is referred to as an upper pretilt value, and is an angle at which the liquid crystal molecule 310 is pretilted by the upper alignment layer 211.

Meanwhile, the long axis of the liquid crystal molecule 310 in the lower pretilt region LP is arranged in a beta vector direction. In FIG. 5, the beta vector direction is shown in detail, and is parallel to the short edge direction of the substrates 110 and 210, thereby forming the angle θ2 from the +z axis. Here, the angle θ2 is referred to as a lower pretilt value, and is the angle at which the liquid crystal molecule 310 is pretilted by the lower alignment layer 111.

The pretilt regions UP and LP in one liquid crystal layer 3 are portions near the alignment layers 111 and 211, and the rest is all included in the middle region M. As a result, the transmittance of light is mainly influenced by the arrangement of the liquid crystal molecule 310 in the middle region M. The liquid crystal molecule in the middle region M is arranged while receiving the influence of the liquid crystal molecules 310 that are pretilted in the upper and lower pretilt regions UP and LP. The middle region M has a wide range such that the arrangement directions of the liquid crystal molecules may be slightly different according to the position.

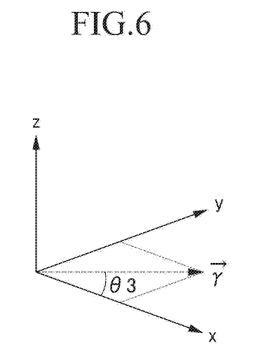

The liquid crystal alignment direction in the domain III is the average direction of the arrangement direction of the liquid crystal molecules in the pretilt regions UP and LP and the middle region M. This is shown as the liquid crystal molecule having the gamma vector direction in FIG. 3. According to FIG. 6, the gamma vector direction forms the angle θ3 with respect to the long edge direction of the substrates 110 and 210, hereafter the angle θ3 is referred to as the liquid crystal alignment angle.

In the exemplary embodiment of FIG. 2, the upper pretilt θ1 of the upper alignment layer 211 is larger than the lower pretilt θ2 of the lower alignment layer 111. Accordingly, the liquid crystal molecule in the middle region M is further influenced by the pretilt θ1 of the upper alignment layer 211 such that the liquid crystal alignment direction is formed like the gamma vector direction, and thereby the component of the long edge direction is larger and the liquid crystal alignment angle θ3 has a value of less than 45 degrees.

If the liquid crystal molecule arranged by the large pretilt among the upper pretilt and the lower pretilt is reflected to one substrate, the liquid crystal molecule is parallel to the long edge direction (referring to FIG. 4).

FIG. 6 shows that the gamma vector direction (the liquid crystal alignment direction) exists in the x and y horizontal plane, however the average liquid crystal molecule 310 is actually further influenced by the alignment force of the upper alignment layer 211 such that the average alignment directions of the liquid crystal molecules 310 may have an angle that is slightly oblique with respect to the surface to the substrates 110 and 210. However, the liquid crystal alignment direction is displayed with reference to the azimuth as in FIG. 6.

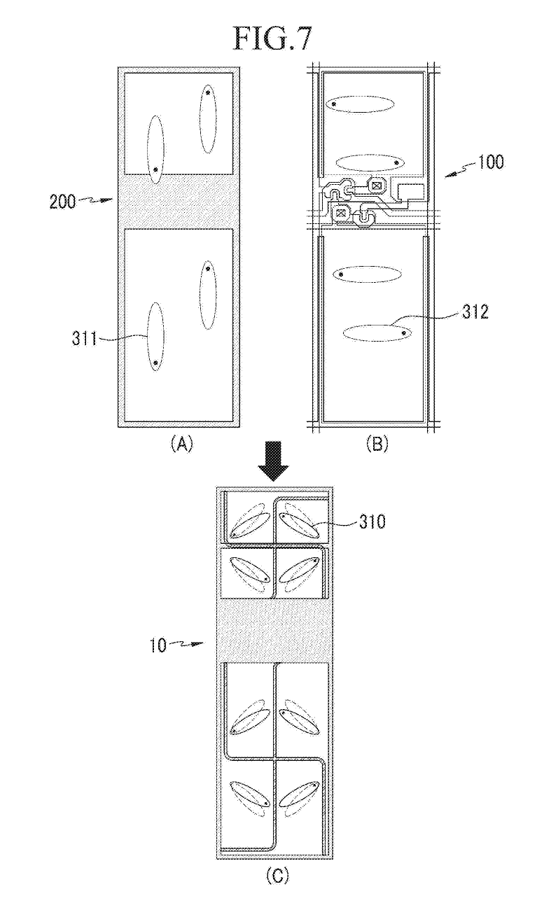

Meanwhile, FIG. 7 is a diagram showing another method of forming the exemplary embodiment of FIG. 1.

FIG. 7 is a diagram showing a method of forming the exemplary embodiment of FIG. 1 as a method that is different from that of FIG. 2.

FIG. 7 is similar to FIG. 2, however alignment layers of the upper panel 200 and the lower panel 100 pretilt the liquid crystal molecules in a different direction from FIG. 2.

The upper panel 200 is divided right and left into two parts such that the alignment layer of the left region is light-aligned for the head portion of the liquid crystal molecule 310 to be toward the lower side, and the alignment layer of the right region is light-aligned for the head portion of the liquid crystal molecule 310 to be toward the upper side (referring to FIG. 7(A)).

Meanwhile, the lower panel 100 is divided up and down into two parts such that the alignment layer of the upper region is light-aligned for the head portion of the liquid crystal molecule 310 to be toward the left side, and the alignment layer of the lower region is light-aligned for the head portion of the liquid crystal molecule 310 to be toward the right side (referring to FIG. 7(B)).

Here, the angle at which the alignment layer of the lower panel 100 pretilts the liquid crystal molecule is larger than the pretilt angle of the alignment layer of the upper panel 200. As a result, as shown in FIG. 7(C), the alignment direction of the liquid crystal molecule has more of the long edge direction component than the short edge direction component.

As a result, the left and right side visibility is improved.

In FIG. 2 and FIG. 7, the alignment layers of the upper panel 200 and the lower panel 100 pretilt the liquid crystal molecules.

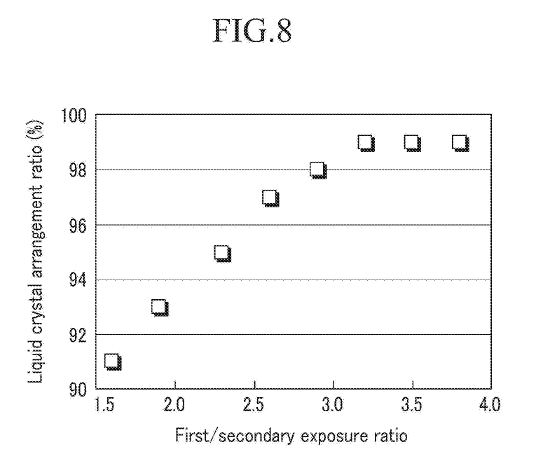

However, FIG. 8 to FIG. 10 show a method of forming the liquid crystal display like FIG. 1 through two photo-alignments for only one display panel.

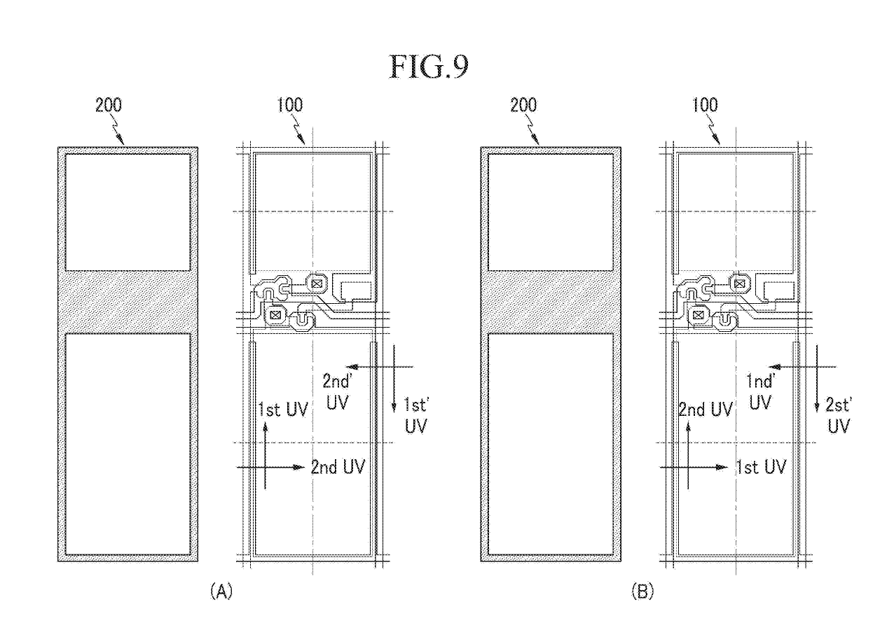

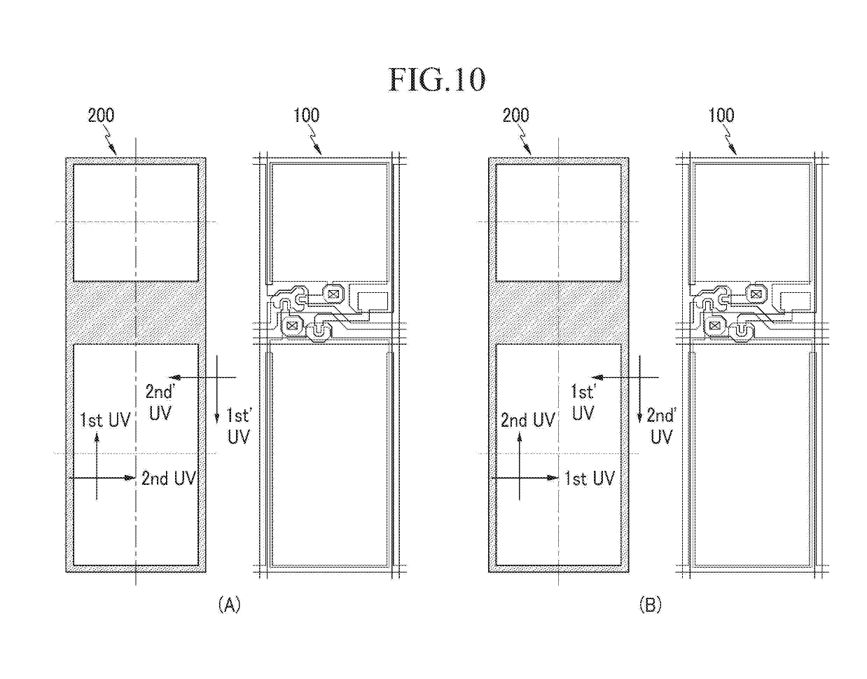

Firstly, FIG. 8 is a graph of a characteristic of liquid crystal that is arranged under two exposures in an exemplary embodiment of the present invention, and FIG. 9 and FIG. 10 are layout views showing a manufacturing method of a liquid crystal display according to another exemplary embodiment of the present invention.

According to FIG. 8, in a case that one alignment layer is light-aligned through two exposures in opposite directions, a ratio for each arrangement direction of the liquid crystal molecule to be 45 degrees (“a liquid crystal arrangement ratio (%)” in FIG. 8) is shown as a graph. That is, the horizontal axis of the graph is a value of which the first exposure amount is divided by the second exposure amount, and the vertical axis of the graph is the ratio (%) of which the liquid crystal molecule is arranged at 45 degrees.

That is, to arrange about 99% of the liquid crystal molecules at 45 degrees, the value of the first exposure amount/the second exposure must be over 3.0, and a value of about 0.33 is required. This is the because the second exposure amount has a greater influence than the first exposure amount such that the first exposure amount must be more than three times the second exposure amount. Through this result, the photo-alignment of 45 degrees is possible by controlling the first exposure amount and the second exposure amount to 3:1, and the ratio of the liquid crystal molecules being arranged in the second exposure direction is increased by a reduction of the first exposure amount. Therefore, in the case that the second exposure direction is the long edge direction of the substrate, the arrangement direction of the liquid crystal molecule includes a large component of the second exposure direction such that the right and left side visibility may be improved.

FIG. 9 shows the case that the lower substrate undergoes two photo-alignment treatments, and FIG. 10 shows the case that the upper substrate undergoes two photo-alignment treatments. The photo-alignment directions of 1st and 1st′ in the exemplary embodiment shown in FIG. 9 and FIG. 10 may be exchanged, and the photo-alignment direction of 2nd and 2nd′ may be exchanged.

FIG. 9(A) and FIG. 9(B) show exemplary embodiments in which the exposure direction of the first and second ultraviolet rays (UV) are different.

Firstly, in FIG. 9(A), the high gray subpixel H and the low gray subpixel L are divided right and left by the one-point chain line (---), and the alignment layer is light-aligned in the left region for the liquid crystal molecule to be pretilted in the 1st direction and for the liquid crystal molecule to be pretilted in the 1st′ direction. For the first exposure, the right region is covered by a mask during the photo-alignment of the left region, and the left region is covered by a mask during the photo-alignment of the right region.

Next, like the dotted line (---), the high gray subpixel H and the low gray subpixel L are divided up and down, and the alignment layer is light-aligned for the liquid crystal molecule to be pretilted in the 2nd direction in the lower region, and for the liquid crystal molecule to be pretilted in the 2nd′ direction in the upper region.

In the exemplary embodiment of FIG. 1, the alignment direction of the liquid crystal molecule further include the component of the long edge direction rather than the component of the cross-sectional direction such that the first exposure amount and the second exposure amount are controlled with reference to FIG. 8 to have the larger pretilt value in the 2nd direction and the 2nd′ direction.

Meanwhile, FIG. 9(B) shows an exemplary embodiment in which they are divided up and down like the dotted line (---) and the alignment layer is light-aligned for the liquid crystal molecule to be pretilted in the 1st direction and the 1st′ direction (the first exposure), and then they are divided right and left like the one-point chain line (---) and the alignment layer is light-aligned for the liquid crystal molecule to be pretilted in the 2nd direction and the 2nd′ direction (the second exposure).

In the exemplary embodiment of FIG. 10, the exposure amount of the first exposure and the second exposure is controlled with reference to FIG. 8 to further have the component of the long edge direction (the 1st direction and the 1st′ direction) of the liquid crystal molecule rather than the component of the short edge direction.

On the other hand, FIG. 10 shows an exemplary embodiment wherein twice light-aligning the upper panel 200 is performed differently from FIG. 9.

FIG. 10(A) shows an exemplary embodiment in which they are divided right and left like the one-point chain line (---) and the alignment layer is light-aligned for the liquid crystal molecule to be pretilted in the 1st direction and the 1st′ direction (the first exposure), and then they are divided up and down like the dotted line (---) and the alignment layer is light-aligned for the liquid crystal molecule to be pretilted in the 2nd direction and the 2nd′ direction (the second exposure).

Also, FIG. 10(B) shows an exemplary embodiment in which they are divided up and down like the dotted line (---) and the alignment layer is light-aligned for the liquid crystal molecule to be pretilted in the 1st direction and the 1st′ direction (the first exposure), and then they are divided by the one-point chain line (---) and the alignment layer is light-aligned for the liquid crystal molecule to be pretilted in the 2nd direction and the 2nd′ direction (the second exposure). In the exemplary embodiment of FIG. 10, the exposure amount of the first exposure and the second exposure is also controlled with reference to FIG. 8 for the alignment direction of the liquid crystal molecule to further have the component of the long edge direction rather than the component of the short edge direction.

The present invention has a basic concept that the pretilt value by the upper alignment layer does not accord with the pretilt value of the lower alignment layer, and FIG. 1 shows the case that the value with which it is pretilted with reference to the long edge direction is large.

As described above, the present invention provides the different alignment forces, and the different alignment forces function for the liquid crystal molecules to have different pretilt values in the pretilt region.

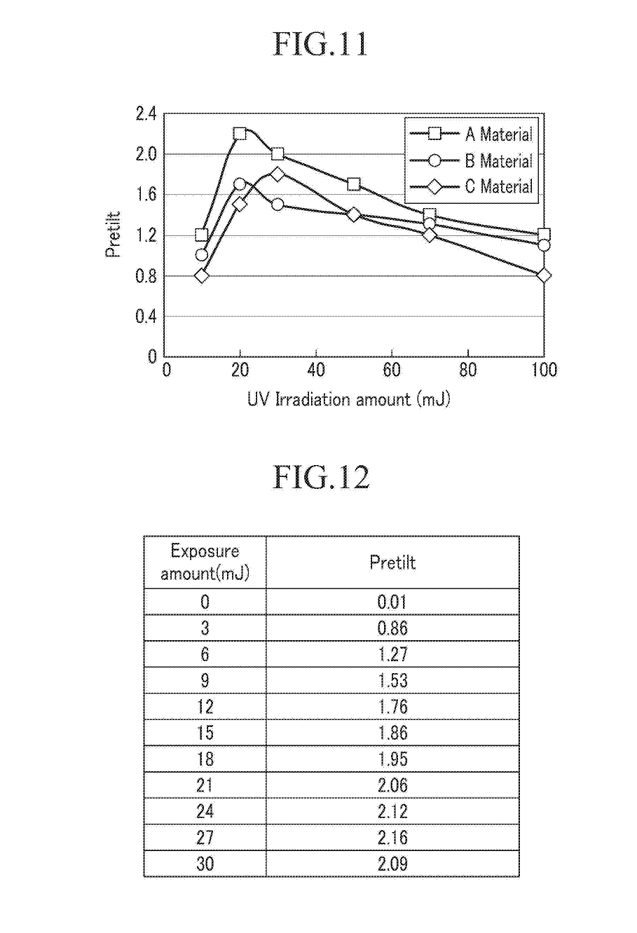

For this purpose, exemplary embodiments controlling the pretilt value of the liquid crystal molecule in the pretilt region by controlling an irradiation amount of ultraviolet (UV) rays will be described with reference to FIG. 11 to FIG. 13.

FIG. 11 to FIG. 13 are graphs and a table showing a pretilt value according to an irradiation amount of ultraviolet rays according to exemplary embodiments of the present invention.

FIG. 11 shows the value that the alignment layer pretilts the liquid crystal molecule according to the irradiation amount of ultraviolet (UV) rays that are irradiated to the alignment layer. Results of an experiment using three materials are shown in FIG. 11.

According to FIG. 11, if the exposure amount of ultraviolet rays that are irradiated to the alignment layer is increased, the pretilt value of the liquid crystal molecule is increased, and if the exposure amount is over a predetermined degree, the pretilt value is also decreased while the alignment force of the liquid crystal molecule is decreased.

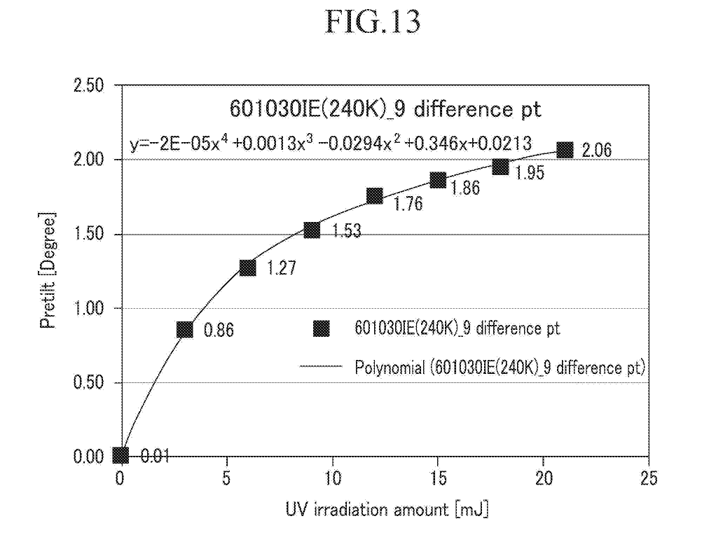

FIG. 12 and FIG. 13 show a table and a graph showing values of calculated exposure amount and the pretilt according to an equation of FIG. 13 based on a material A among the exemplary embodiments of FIG. 11.

According to FIG. 12 and FIG. 13, the irradiation amount of ultraviolet rays is controlled in the range of 0 to 30 mJ such that the pretilt angle may be controlled to a maximum of 2.16 degrees. The irradiation amount of ultraviolet rays for the substrate is controlled based on these values in the exemplary embodiment of FIG. 2 or FIG. 7 to increase the alignment force of the long edge direction of each alignment layer such that the right and left visibility may be improved.

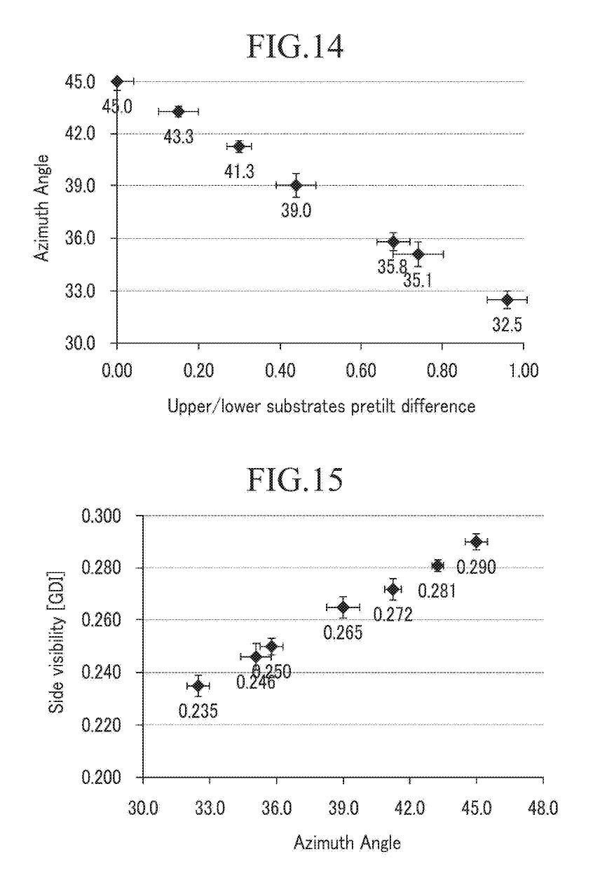

This will be described in detail with reference to FIG. 14 and FIG. 15.

FIG. 14 is a graph showing an alignment angel of a liquid crystal according to a pretilt difference of lower and upper panels in an exemplary embodiment of the present invention, and FIG. 15 is a graph of a change of a visibility index (GDI) of a side according to an alignment angel of liquid crystal in an exemplary embodiment of the present invention.

The values shown in FIG. 14 and FIG. 15 are rearranged to Table 1 as one table.

TABLE 1

| Lower and upper | Liquid crystal | |
|---|---|---|
| panels | alignment angle | Side visibility |
| pretilt difference | (azimuth angle) | (GDI) |
| 0.00 | 45.0 | 0.290 |
| 0.15 | 43.3 | 0.281 |
| 0.30 | 41.3 | 0.272 |
| 0.44 | 39.0 | 0.265 |
| 0.68 | 35.8 | 0.250 |
| 0.74 | 35.1 | 0.246 |
| 0.96 | 32.5 | 0.235 |

Referring to FIG. 14, FIG. 15, and Table 1, it may be confirmed that the alignment angle is changed (the azimuth angle of the liquid crystal is changed due to the difference of the angle of pretilt of the liquid crystal molecule by each alignment layer of the upper panel and the lower panel, and thereby the side visibility) (GDI: gamma distortion index).

Firstly, FIG. 14 shows cases in which the difference of the pretilted angle of liquid crystal molecules in the upper panel and the lower panel is generated in the range from about 0.00 to about 1 degree (0.96 degree). According to FIG. 14, it may be confirmed that the alignment angle of the liquid crystal is 45 degrees in the case that the difference of the angles (the pretilt angles) pretilted through the upper panel and the lower panel is not generated, and the alignment direction of the liquid crystal is biased in one direction according to the generation of the difference of the pretilt angle and the angle is decreased. When the pretilt difference of about 1 degree (0.96 degrees) is generated, the alignment angle of the liquid crystal of 12.5 degrees is changed in the present exemplary embodiment.

Meanwhile, FIG. 15 shows the side visibility index (GDI) when the alignment angle of the liquid crystal is changed by 12.5 degrees, from 45 degrees to 32.5 degrees. Here, the side means the direction that the liquid crystal is aligned in the case that the alignment angle of the liquid crystal is 0 degrees.

When the alignment angle of the liquid crystal is 45 degrees, the side visibility index (GDI) is 0.290 and the alignment angle of the liquid crystal is decreased such that the side visibility index (GDI) is decreased, and when the alignment angle of the liquid crystal is 32.5 degrees, the side visibility index (GDI) is 0.235.

To recognize the mean of the value change, it is necessary to recognize the characteristic of the side visibility index and the characteristic of the panel according to the side visibility index.

Firstly, the side visibility index (GDI: gamma distortion index) represents the index showing the distorted value such that it means that the visibility is deteriorated as the value is larger, and the visibility is better as the value is smaller. Therefore, the visibility index (GDI) is the value that is calculated accordingly to the visibility index calculation equation.

On the other hand, in general, when the visibility index (GDI) is over 0.3, deterioration is generated, when it is in the range of 0.3 to 0.27, improvement is required, when it is in the range of 0.25 to 0.27, a good characteristic is represented, and when it is less than 0.25, an excellent characteristic is represented.

Therefore, based on the side visibility index (GDI), when the pretilt difference of the upper and the lower panels is in the range of 0.00-0.30, the alignment angle of the liquid crystal has the range of 45 degrees-41.3 degrees, and when the side visibility index (GDI) is in the range of 0.290-0.272, improvement of the side visibility is required. On the other hand, when the pretilt difference of the upper and lower panels is in the range of more than 0.30 and less than 0.68, the liquid crystal alignment angle is in the range of less than 41.3 degrees and more than 35.8 degrees, and the side visibility index GDI is in the range of less than 0.272 and more than 0.250 such that the side visibility has is good. Finally, when the pretilt difference of the upper and lower panels is under the value, the side visibility is excellent.

Therefore, the side visibility index (GDI) of the liquid crystal display according to the present invention uses the range of 0.25 to 0.27, and a range of less than 0.25 is possible.

According to FIG. 14 and FIG. 15, to improve the visibility by reducing the visibility index (GDI) by 0.01, it is necessary to generate a pretilt difference of about 0.17 degrees between the upper and lower alignment layers. This is the reason that it may be confirmed that the visibility index (GDI) may be improved by 0.055=(0.290−0.235) due to the total pretilt of 0.96 degrees. This value may have an error according to the exemplary embodiments.

Also, in FIG. 14 and FIG. 15, the liquid crystal alignment angle (the azimuth) of the range of 32.5 degrees to 45 degrees is described, however considering the exemplary embodiments and the error, the liquid crystal alignment angle (the azimuth) may have the range of 30 degrees to 45 degrees, and when the liquid crystal alignment angle (the azimuth) is more than 30 degrees and less than 45 degrees, it may be confirmed that the side visibility is improved.

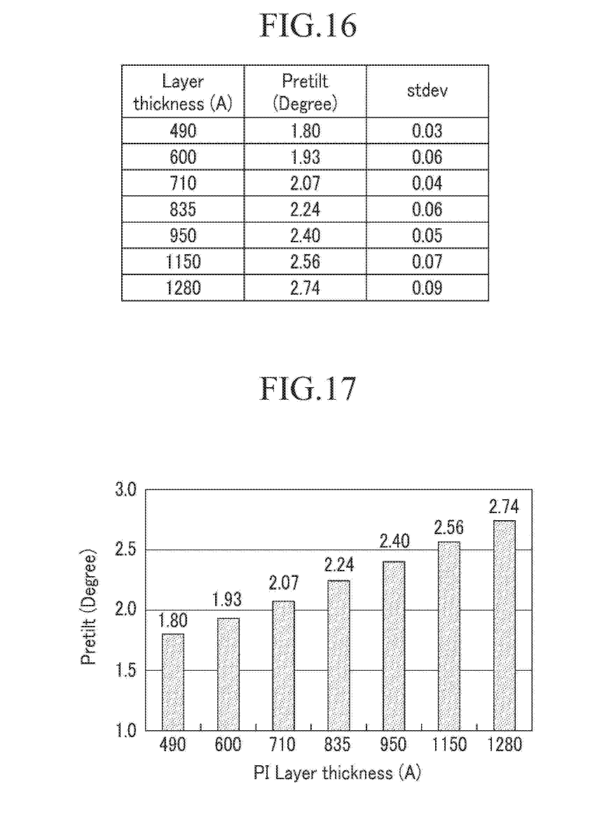

FIG. 16 and FIG. 17 show exemplary embodiments controlling the alignment force of the alignment layer of the upper and lower display panels by adjusting the thickness of the alignment layer.

FIG. 16 and FIG. 17 are a table and a graph showing a change of a pretilt according to thickness of an alignment layer in exemplary embodiments of the present invention.

FIG. 16 is a table showing a change of the pretilt angle of the liquid crystal molecule that is aligned by the alignment layer according to the thickness of the alignment layer, and FIG. 17 is a graph according thereto. “Stdev” in FIG. 16 indicates a deviation value between the pretilt values.

If the thickness of the alignment layer is increased, the pretilt of the liquid crystal molecule arranged by the alignment layer is increased. Therefore, if the alignment layer (the lower alignment layer in the exemplary embodiment of FIG. 7) to arrange the liquid crystal molecule in the long edge direction is thickly formed, the alignment direction of the liquid crystal molecule further have the long edge direction component like in FIG. 1. According to FIG. 16 and FIG. 17, the difference of the pretilt provided by the alignment layer according to the difference of the thickness of the alignment layer may be provided at about 0.94, and the visibility index of 0.01 is improved every pretilt of 0.17 such that the visibility index (GDI) may be decreased by about 0.06 and the side visibility is improved.

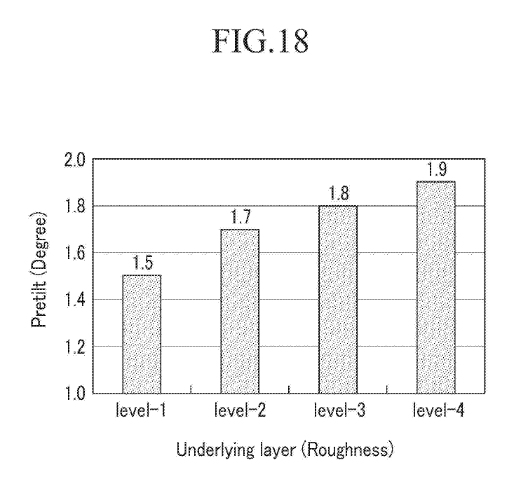

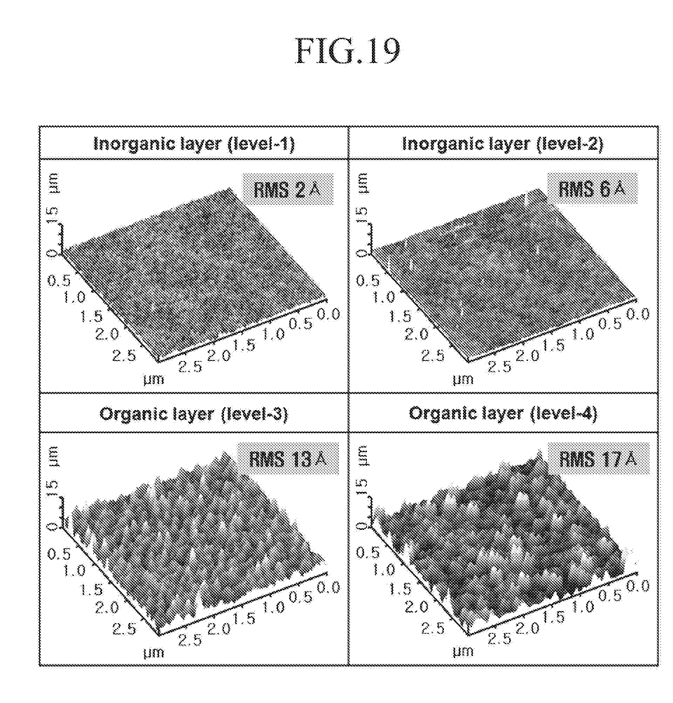

FIG. 18 and FIG. 19 show the change of the pretilt value of the liquid crystal molecule arranged by the alignment layer according to the surface flatness of a layer positioned between the alignment layer and the substrate.

FIG. 18 is a graph showing a change of a pretilt according to flatness of a layer under an alignment layer in an exemplary embodiment of the present invention, and FIG. 19 is an enlarged photograph of a surface of each lower layer of FIG. 18.

Firstly, FIG. 18 includes four experimental data, wherein the data is indicated by level-1, level-2, level-3, and level-4, and FIG. 19 shows photographs thereof. Firstly, level-1 and level-2 represent an inorganic layer and an RMS (root mean square) of a surface height in each layer, and are 2 Å and 6 Å, respectively. On the other hand, level-3 and level-4 represent organic layers, and the RMS (root mean square) of a surface height in each layer, respectively, is 13 Å and 17 Å.

Referring to FIG. 18, as the surface of the layer under the alignment layer is rougher, the pretilt of the liquid crystal molecule aligned by the alignment layer is increased. Therefore, the pretilt of the liquid crystal molecule aligned by the alignment layer may be controlled by controlling the surface roughness of the layer formed under the alignment layer. At a result, the upper and lower panels may be formed to have an asymmetric pretilt as in FIG. 1. According to FIG. 18, the difference of the pretilt provided by the alignment layer according to the surface roughness of the underlying layer may be about 0.4, and the visibility index of 0.01 is improved for every pretilt of 0.17 such that the visibility index (GDI) may be decreased by about 0.02 and the side visibility is improved.

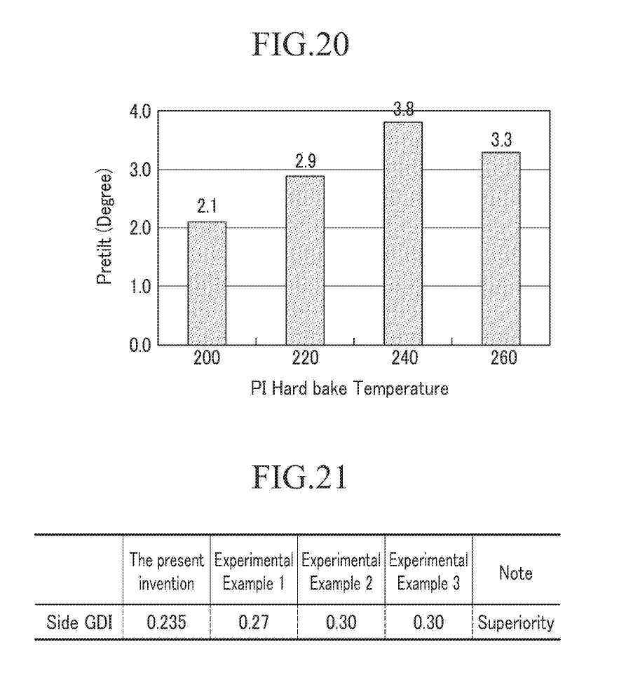

FIG. 20 shows the change of the pretilt value of the liquid crystal molecule aligned by the alignment layer according to a process temperature (hereinafter, “a hardening temperature”) when baking the alignment layer.

FIG. 20 is a graph showing a change of a pretilt according to a temperature of baking an alignment layer in an exemplary embodiment of the present invention.

According to FIG. 20, the difference of the pretilt provided by the upper alignment layer and the lower alignment layer according to the hardening temperature may be about 1.7, and the visibility index of 0.01 is improved for every pretilt of 0.17 such that the visibility index (GDI) may be decreased by about 0.1 and the side visibility is improved.

FIG. 21 is a table comparing a side visibility index (GDI) for a liquid crystal display according to FIG. 1 of the present invention and another liquid crystal display sold in the market.

The present invention has a visibility index (GDI) to 0.235 as described above. However, the liquid crystal display (Comparative Example 2 and Comparative Example 3) sold in the market has a visibility index of 0.30 of which improvement is required, and the other one (Comparative Example 1) has good visibility of 0.27, however it is not a structure in which the pretilts of the upper and lower alignment layers are different like the present invention. Also, according to the present invention, the visibility index may be reduced to 0.235 such that the side visibility may be improved.

However, if the side visibility is improved, the transmittance may be decreased such that it is not appropriate to only decrease the visibility index to manufacture the liquid crystal display and the liquid crystal display may be manufactured to have a visibility index (GDI) of a good degree (from 0.25 to 0.27). In the above, the pretilts provided by the alignment layer in the high gray subpixel H and the low gray subpixel L are not different, and the exemplary embodiment in which the pretilts of the liquid crystal molecules aligned by the upper alignment layer and the lower alignment layer are different are described.

Next, an exemplary embodiment in which the pretilts provided by the alignment layer in the high gray subpixel H and the low gray subpixel L are different will be described.

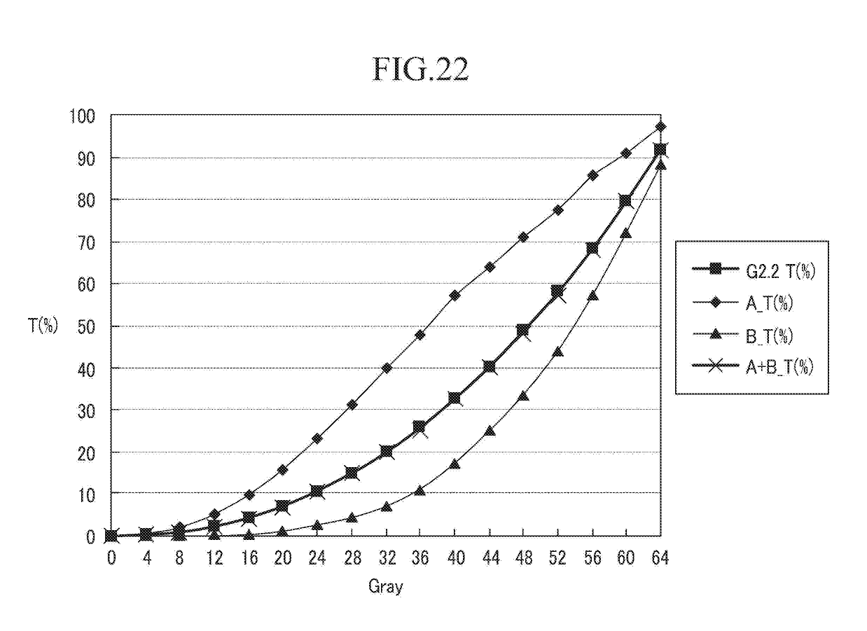

FIG. 22 is a graph showing a gamma curve of a high gray subpixel and a low gray subpixel in exemplary embodiments of the present invention.

As shown in FIG. 22, a high gray gamma curve A_T and a low gray gamma curve B_T are divided with reference to a 2.2 gamma curve G2.2 T, and a portion of the region displays the luminance according to the high gray gamma curve A_T and the remaining portion displays the luminance according to the low gray gamma curve B_T in one pixel, thereby improving the side visibility. As shown in FIG. 22, a sum A+B_T of the high gray gamma curve A_T and the low gray gamma curve B_T is the same as the 2.2 gamma curve G2.2 T.

As described above, the invention in which one pixel is divided into two subpixels (the high gray subpixel and the low gray subpixel) to improve the side visibility is provided in a conventional art. However, the conventional art controls a voltage ratio or an area ratio of a low gray subpixel to display the luminance of the high gray subpixel and the low gray subpixel according to the high gray gamma curve A_T and the low gray gamma curve B_T of FIG. 22. As described above, when controlling the voltage ratio or the area ratio of the low gray subpixel, the side visibility is improved, however the transmittance is deteriorated such that the maximum luminance is decreased. Accordingly, in the present invention, the applied voltage ratio or the subpixel area ratio is not controlled and the degree of pretilt of the liquid crystal molecule by the portion of the alignment layer is controlled to be different, and as a result, the high gray subpixel and the low gray subpixel display the luminance according to the high gray gamma curve A_T and the low gray gamma curve B_T.

In the present invention, if the pretilts are different in the high gray subpixel and the low gray subpixel to improve the side visibility, the manufacturing of the liquid crystal display is easy. Also, in exemplary embodiments of the present invention, in the structure in which the high gray subpixel is smaller than the low gray subpixel, the alignment direction of the liquid crystal molecule has a greater long edge side component in the high gray subpixel to improve the side visibility. Meanwhile, the alignment direction of the liquid crystal molecule forms a 45 degree angle with respect to the long edge direction in the low gray subpixel such that the maximum transmittance may be maintained. As a result, the luminance may be partially reduced in the high gray subpixel that is small in one pixel, however the high gray subpixel improves the side visibility, and the wide low gray subpixel may continuously display the maximum luminance such that the reduction of the luminance is not recognized and the side visibility may be improved.

A different method (the alignment direction of the low gray subpixel is formed in a different direction from 45 degrees) may be provided according to exemplary embodiments while decreasing the display luminance.

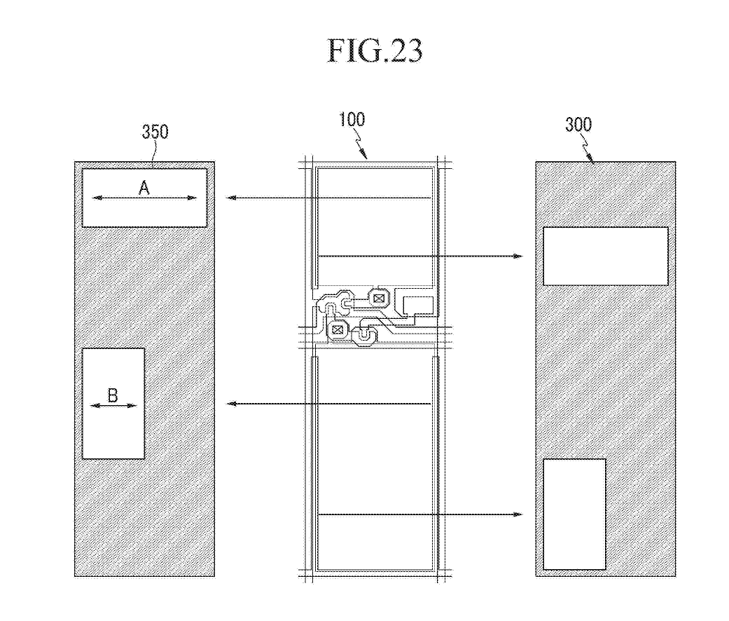

A liquid crystal display formed with a method in which the exposure amount is different in the high gray subpixel and the low gray subpixel will be described with regard to FIG. 23 to FIG. 27.

FIG. 23 is a view showing a manufacturing method of a liquid crystal display according to exemplary embodiments of the present invention, and FIG. 24 to FIG. 27 are cross-sectional views showing a method of FIG. 23.

As shown in the exemplary embodiment of FIG. 7, the upper panel 200 is bisected right and left and is light-aligned in the opposite direction, (referring to FIG. 7(A)) the lower panel 100 is bisected up and down, the alignment layer is light-aligned for the head portion of the liquid crystal molecule 310 to be toward the left side in the upper region, and the alignment layer is light-aligned for the head portion of the liquid crystal molecule 310 to be toward the right side (referring to FIG. 7(B)).

As described above, when light-aligning the upper panel 200 and the lower panel 100 in different directions, the exposure amount of the photo-alignment of the lower panel 100 is controlled for the alignment layers of the high gray subpixel and the low gray subpixel to have the different pretilts, an exemplary embodiment of which is shown in FIG. 23.

As shown in FIG. 23, a mask 300 includes an opening 350, wherein the opening 350 corresponding to the high gray subpixel has a wide width A, and the opening 350 corresponding to the low gray subpixel has a small width B. Also, ultraviolet rays are irradiated while moving at least one of the mask 300 or the lower panel 100 in one direction. FIG. 23 shows the lower panel 100 that is moved, and when the ultraviolet rays are irradiated to the upper region of the high gray subpixel and the low gray subpixel, the lower panel 100 while moving to the left side passes by the mask 300 of the left side. As shown in FIG. 24 and FIG. 25, ultraviolet rays incident in the oblique direction to the substrate from the light exposer 371 are incident to the lower panel 100 (or the upper panel 200) through the opening 350 of the mask 300. As a result, the alignment layer (not shown) of the lower panel 100 pretilts the liquid crystal molecule in the direction that the ultraviolet rays are incident. Here, the high gray subpixel of the lower panel 100 corresponding to the opening of the width A is exposed for a relatively long time compared with the low gray subpixel corresponding to the opening of the width B such that the alignment force of the alignment layer is increased. On the other hand, when the alignment force is over a predetermined degree as in FIG. 11, the pretilt may be decreased by the alignment force such that it is necessary to control the exposure amount.

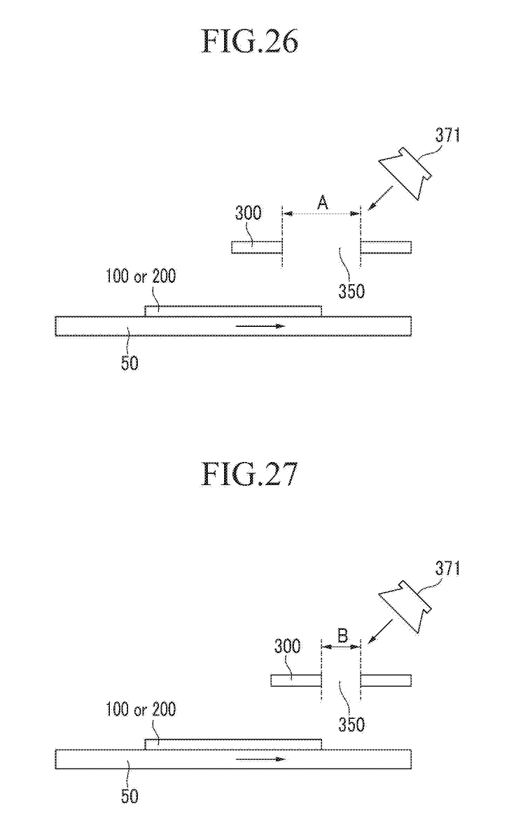

Also, when exposing the lower region of the high gray subpixel and the low gray subpixel, the lower panel 100 while moving in the right side passes by the mask 300 of the right side. As shown in FIG. 26 and FIG. 27, the exposure is processed, and as a result, the alignment layer (not shown) of the lower panel 100 pretilts the liquid crystal molecule in the direction that ultraviolet rays are incident. Here, the high gray subpixel of the lower panel 100 corresponding to the opening of the width A is exposed for a relatively long time compared with the low gray subpixel corresponding to the opening of the width B such that the alignment force of the alignment layer is increased.

Therefore, the alignment layer aligns the liquid crystal molecules through a larger alignment force in the high gray subpixel than in the low gray subpixel by the larger exposure amount such that the high gray subpixel and the low gray subpixel have the different alignment directions of the liquid crystal molecules. In FIG. 23, the mask 300 is shown as if it is disposed at the right and the left sides of the lower panel 100, however this only shows two processes as one picture, and one mask is used in one photo-alignment exposure process.

Meanwhile, when the alignment force is over the predetermined degree as in FIG. 11, the pretilt may be decreased by the alignment force such that it is necessary to control the exposure amount.

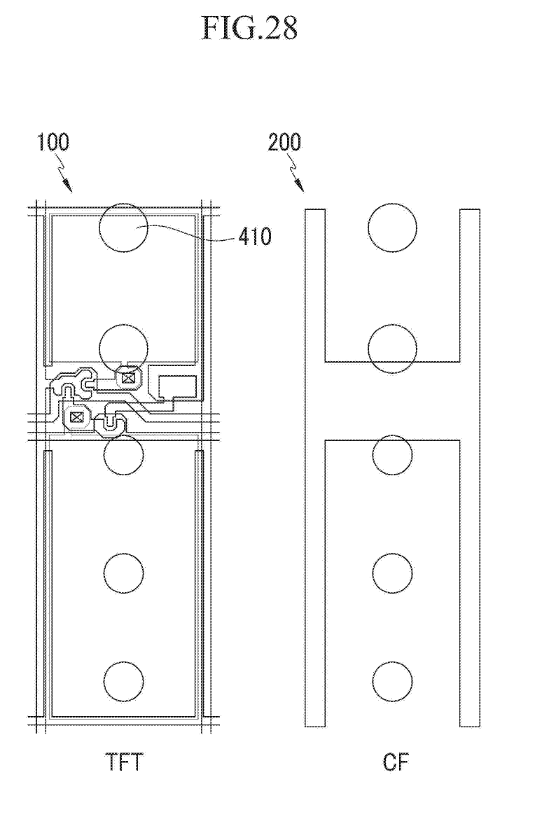

FIG. 28 to FIG. 32 show ways of controlling the characteristic of the alignment layer formed in the display panel to provide the different alignment forces to the high gray subpixel and the low gray subpixel.

Firstly, FIG. 28 to FIG. 30 show a case having different alignment forces according to the thickness of the alignment layer.

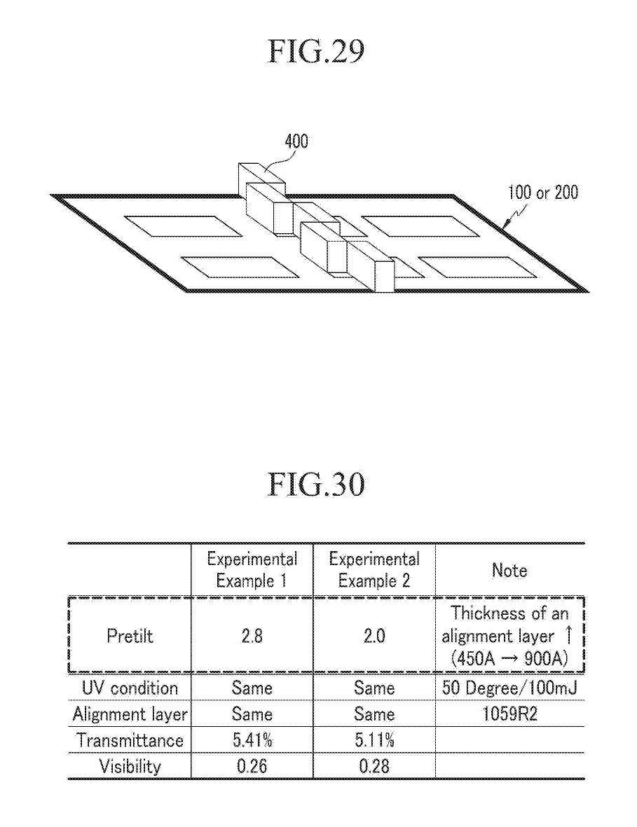

FIG. 28 is a view showing a manufacturing method of a liquid crystal display according to exemplary embodiments of the present invention, FIG. 29 is a view showing a portion of an inkjet sprayer used to manufacture the liquid crystal display of FIG. 28, and FIG. 30 is a table showing a relationship of thickness and a pretilt of an alignment layer according to the exemplary embodiment of FIG. 28.

For example, an inkjet sprayer is used to control the thickness of the alignment layer. A portion of the used inkjet sprayer is shown in FIG. 29, and FIG. 29 shows focusing of a nozzle 400.

The thicknesses of the alignment layers of the high gray subpixel and the low gray subpixel are controlled by controlling the amount of the aligning agent 410 (in general, a polyimide (PI) is included) sprayed from the nozzle 400 of the inkjet sprayer. As shown in FIG. 28, it may be confirmed that the high gray subpixel includes a large amount of the aligning agent 410 sprayed from the nozzle 400. The aligning agent 410 is sprayed while having the difference between the upper panel 200 and the lower panel 100.

According to FIG. 30, comparing the pretilt, the transmittance, and the visibility for Experimental Examples 1 and 2, the thickness of the alignment layer is 900 Å in Experimental Example 1 and the thickness of the alignment layer is 450 Å in Experimental Example 2. As a result, it may be confirmed that the transmittance and the visibility are excellent and the pretilt is also excellent in Experimental Example 1 having the thick alignment layer. As described, ultraviolet rays (UV) are irradiated with energy of 100 mJ while forming 50 degrees with respect to the vertical surface to the substrate surface, and the material of the alignment layer is the same material as 1059R2.

Therefore, like FIG. 28, when the aligning agent 410 is largely sprayed to the high gray subpixel to form the alignment layer, the pretilt is large and the transmittance and the visibility may be improved in the high gray subpixel.

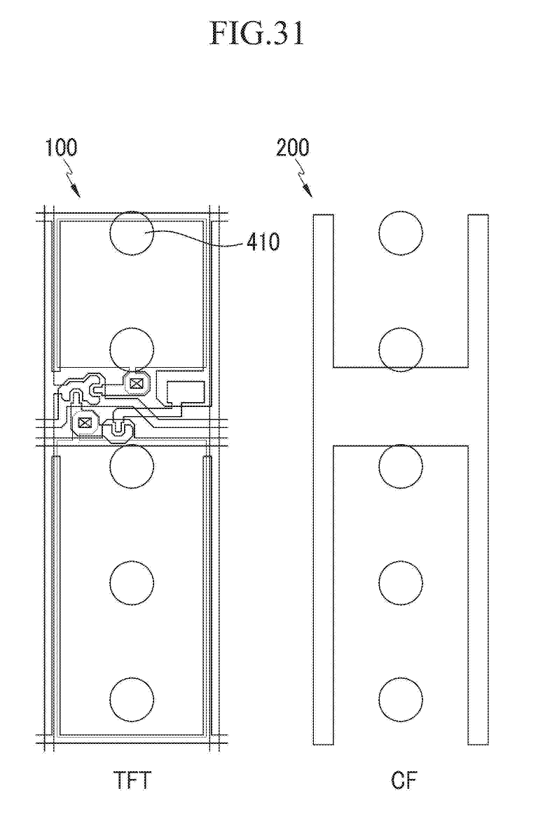

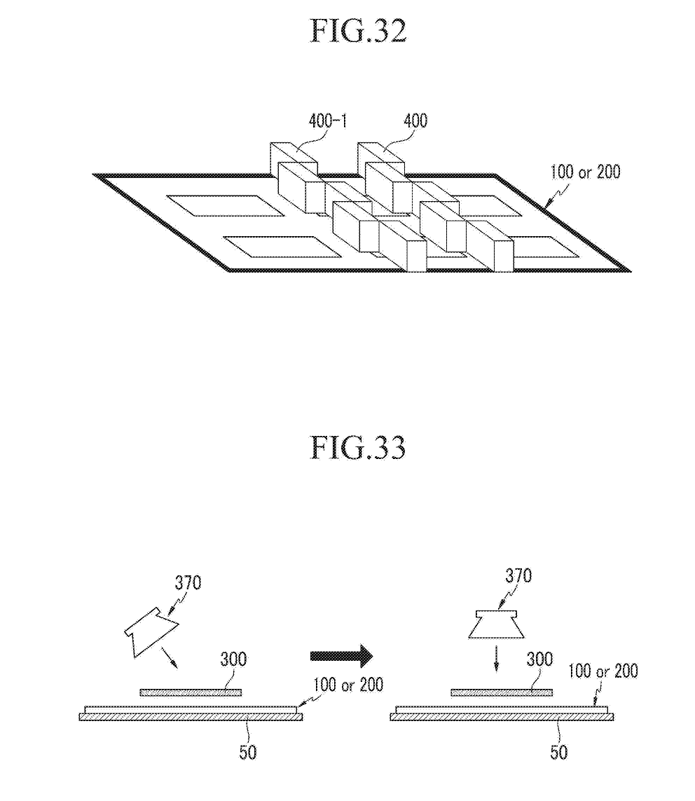

Meanwhile, exemplary embodiments for forming the different pretilt by the alignment force is described by using a different material and a different amount for the alignment layer in FIG. 31 and FIG. 32.

FIG. 31 is a view showing a manufacturing method of a liquid crystal display according to exemplary embodiments of the present invention, and FIG. 32 is a view showing a portion of an inkjet sprayer used to manufacture the liquid crystal display of FIG. 31.

FIG. 31 shows a point that there is no difference in the amount of the aligning agent 410 sprayed from the nozzle between the high gray subpixel and the low gray subpixel. However, the aligning agents 410 sprayed to the high gray subpixel and the low gray subpixel have different components.

Firstly, the aligning agent 410 sprayed to the high gray subpixel is light-reacted by ultraviolet rays such that the amount of the light additive aligning the liquid crystal molecule is relatively high, and the amount of a vertical additive (an additive to align the liquid crystal molecule in the vertical direction) is relatively low. As a result, although the same exposure amount is irradiated, the alignment force aligning in the direction of the light source is further increased. On the other hand, the aligning agent 410 sprayed to the low gray subpixel includes a relatively low amount of the light additive and a relatively high amount of the vertical additive such that the liquid crystal molecule is largely aligned in the vertical direction although the exposure amount is irradiated. As a result, it is possible for the alignment layer of the high gray subpixel to form a relatively large pretilt of the liquid crystal molecule.

The alignment layer formed in the high gray subpixel and the low gray subpixel includes a material of different amounts (or a different material according to exemplary embodiments) such that it is preferable that different nozzles 400 and 400-1 are used (referring to FIG. 32).

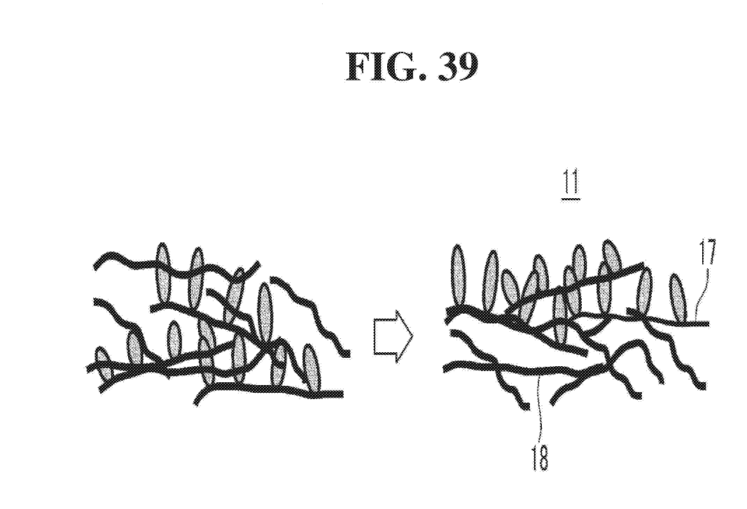

Meanwhile, the component of the additive included in the aligning agent 410 may be various, and the component may be included as shown in FIG. 39.

As seen in FIG. 39, the alignment layer, according to exemplary embodiments of the present invention, is formed with a mixture of a vertical photo-alignment material 17 containing a vertical functional group in the side chain thereof, and a major alignment material 18 that is generally used in the vertical alignment (VA) mode liquid crystal display. The vertical photo-alignment material 17 and the major alignment material 18 are induced to a micro-phase separation (MPS) state. The micro-phase separation state of the alignment layer may be generated when the vertical photo-alignment material 17 and the major alignment material 18 are mixed, coated, and hardened. Ultraviolet rays are illuminated to the alignment layer with the micro-phase separation structure, and as a result, the alignment layer is finally formed by way of the reaction of a photo-reactive group. Few side products due to the illumination of ultraviolet rays occur in the alignment layer, and the afterimages of the liquid crystal display are reduced. Furthermore, as the alignment layers are formed only by way of the illumination of ultraviolet rays without performing a rubbing process in a separate manner, the production cost is reduced and the production speed is increased. The vertical photo-alignment material 17 is mainly formed on the surface side closer to the liquid crystal layer, and the major alignment material 18 is mainly formed closer to the substrates. Accordingly, toward the surface of the alignment layer closer to the liquid crystal layer, the molar concentration ratio of the vertical photo-alignment material 17 to the major alignment material 18 may be increased. The vertical functional group contained in the vertical photo-alignment material 17 may exist from the surface of the alignment layer to a depth of the alignment layer corresponding to roughly 20% of the entire thickness thereof, and in this case, the micro-phase separation structure may be formed more clearly.

The vertical photo-alignment material 17 is a polymer material with a weight average molecular weight of roughly 1000 to 1,000,000, and is a compound having a main chain bonded with at least one side chain. The side chain includes a flexible functional group, a thermoplastic functional group, a photo-reactive group 16, a vertical functional group, etc. The main chain 17 may include at least one material selected from a polyimide, polyamic acid, polyamide, polyamicimide, polyester, polyethylene, polyurethane, or polystyrene.

The vertical photo-alignment material 17 may be prepared by polymerizing a monomer such as diamine bonded with a side chain such as a flexible functional group, a photo-reactive group, and a vertical functional group with acid anhydride. For example, the diamine and the acid anhydride are reacted at 50 mol %:50 mol %, and thereby the polyimide group polymer or the polyamic acid group polymer may be polymerized. Also, at least one kind of diamine may be used for the polymerization reaction, and at least one kind of acid anhydride may be used for the polymerization reaction. That is, the vertical photo-alignment material 17 may be homopolymer or a copolymer.

In detail, the diamine may be a photo-reactive diamine, a vertical diamine, and a normal diamine. At least one diamine among a photo-reactive diamine, a vertical diamine, and a normal diamine may be used to the polymerization reaction of the vertical photo-alignment material 17. Also, at least one kind of photo-reactive diamine may be used in the polymerization reaction of the vertical photo-alignment material 17, at least one kind of vertical diamine may be used, and at least one kind normal diamine may be used.

The vertical alignment property and the alignment stability may be optimized by controlling the composition ratio of the copolymer of the photo-reactive diamine, the vertical diamine, and the normal diamine. For example, the photo-reactive diamine may be used in a range of about 40 mol % to about 70 mol %, the vertical diamine may be used in a range of about 10 mol % to about 40 mol %, and the normal diamine may be used in a range of about 0 mol % to about 20 mol %. In detail, the photo-reactive diamine amount may be 60 mol %, the vertical diamine amount may be 30 mol %, and the normal diamine amount may be 10 mol %, but is not limited thereto. Also, to form the alignment layer by using the photo-reactive group at a minimum amount, through the mixture of the vertical photo-alignment material 17 and the major alignment material 18, the minimum photo-reactive group may be positioned at the center or under the alignment layer, and the optimized photo-reactive group may be positioned on the alignment layer. Also, to obtain stability of the alignment layer, at least one of the vertical diamine or the normal diamine may be copolymerized.

The photo-reactive diamine includes a diamine group, a flexible functional group, a photo-reactive group, and a vertical functional group. The vertical diamine includes the diamine group, the flexible functional group, and the vertical functional group, and does not include the photo-reactive group. The normal diamine includes the diamine group, and does not include the photo-reactive group or the vertical functional group.

For example, in the photo-reactive diamine, the flexible functional group may be coupled to the diamine group, the photo-reactive group may be coupled to the flexible functional group, and the vertical functional group may be coupled to the photo-reactive group. In the vertical diamine, the flexible functional group may be coupled to the diamine group, and the vertical functional group may be coupled to the flexible functional group.

The flexible functional group or the thermoplastic functional group is a functional group serving to make the side chain bonded to the main chain that may be easily aligned. For example, the flexible functional group or the thermoplastic functional group may include at least one of —O—, —OCO—, —COO—, —OR— (here, R is H or a C1-C5 alkylene group), —R— (here, R is a C1-C5 alkylene group), and an imide group. Also, the flexible functional group or the thermoplastic functional group may contain a substituted or non-substituted alkylene or alkoxy group with a carbon number of roughly 3 to 20.

The photo-reactive group is a functional group that directly causes a photo-dimerization reaction or a photo-isomerization reaction by way of the illumination of ultraviolet rays. For example, the photo-reactive group may contain at least one compound selected from an azo-based compound, a cinnamate-based compound, a chalcone-based compound, a coumarin-based compound, a maleimide-based compound, but is not limited thereto.

The vertical functional group is a functional group that moves the whole side chain in the direction vertical to the main chain standing parallel to the substrates 110 and 220. For example, it may contain at least one of an alkyl or alkoxy group-substituted aryl group with a carbon number of 1 to 25, or an alkyl or alkoxy group-substituted cyclohexyl group with a carbon number of 1 to 25, and a steroid group, but it is not limited thereto. Here, at least one of an aryl and at least one of a cyclohexyl group may be coupled directly or through a C1-C5 alkylene.

At least one vertical photo-alignment material 17 and at least one major alignment material 18 may be coupled by a cross-linking agent. When adding the cross-linking agent to form the alignment layer, the electrical characteristics of the alignment layer and the chemical stability may be improved. Furthermore, when using the cross-linking agent at less than about 30 wt %, the electrical characteristics and the chemical stability may be further improved.

As a method of forming the vertical photo-alignment material 17, there is a method in which the compound that is coupled with the thermoplastic functional group, the photo-reactive group, and the vertical functional group is added to the above-described polyimide and polyamic acid as an example. In this example, the thermoplastic functional group is directly coupled to the polymer main chain, and the side chain may include the thermoplastic functional group, the photo-reactive group, and the vertical functional group.

The major alignment material 18 does not contain the photo-reactive group and may contain the above-identified polymer main chain, and the weight average molecular weight thereof is about 10,000 to 1,000,000. For example, the diamine and the acid anhydride are reacted at 50 mol %:50 mol % such that the polyimide group polymer or the polyamic acid group may be polymerized. Also, at least one diamine may be used in the polymerization reaction, and at least one acid anhydride may be used in the polymerization reaction. That is, the major alignment material 18 may be a homopolymer or a copolymer. In detail, at least one diamine among the vertical diamine and the normal diamine may be used in the polymerization reaction of the major alignment material 18. Also, at least one kind of vertical diamine and at least one kind of normal diamine may be used in the polymerization reaction of the major alignment material 18.

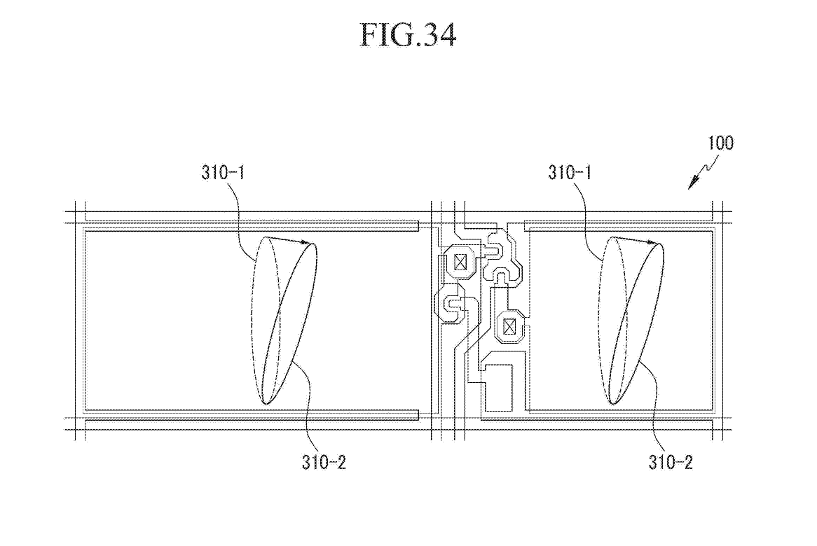

Next, turning to exemplary embodiments of the present invention described with reference to FIG. 33 to FIG. 35, wherein FIG. 33 to FIG. 35 show the different alignment directions of the liquid crystal molecule of the high gray subpixel and the low gray subpixel through light alignment by two exposures.

FIG. 33 to FIG. 35 are views showing a manufacturing method of a liquid crystal display according to exemplary embodiments of the present invention.

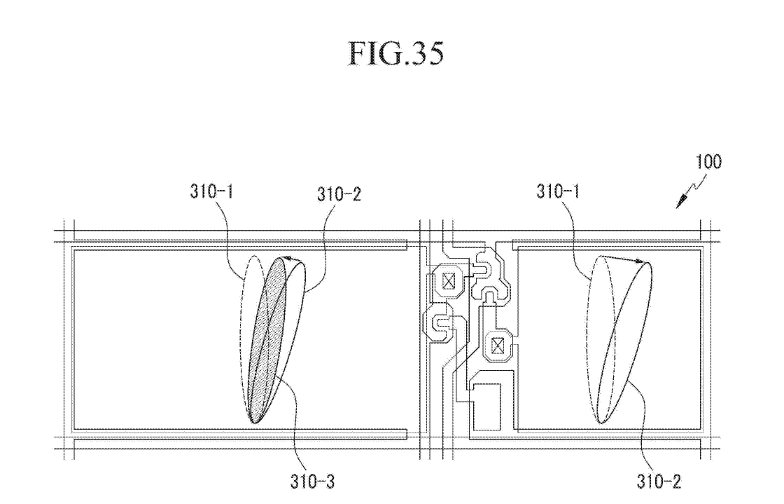

As shown in FIG. 33, light emitted from a light exposer light source 370 is irradiated to the display panels 100 and 200 through the mask 300 including the opening (not shown) (the first exposure) to form the alignment layer for pretilting the liquid crystal molecule in the first direction (referring to 310-2). Next, the second exposure is processed in a different direction from the first exposure to amend the direction of pretilting of the alignment layer (referring to 310-3 of FIG. 35). The second exposure is executed for one subpixel among the high gray subpixel and the low gray subpixel such that the pretilt directions of the alignment layer of the high gray subpixel and the low gray subpixel are different from each other. According to FIG. 35, the second exposure is the vertical exposure (the light is irradiated in the vertical direction with respect to the surface of the substrate) and reduces the pretilt direction of the alignment layer of the low gray subpixel such that the alignment layer of the high gray subpixel has a relatively large pretilt value.

As a result, the side visibility is improved.

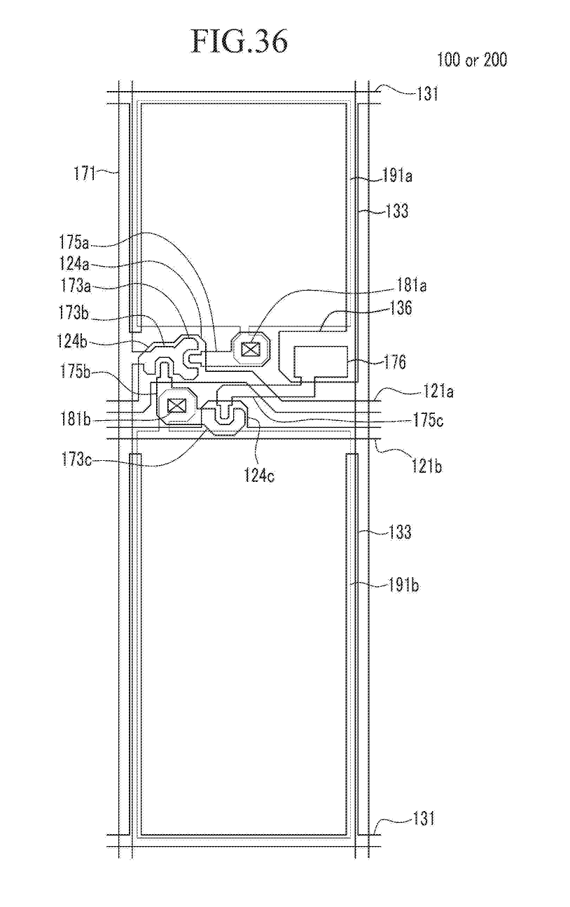

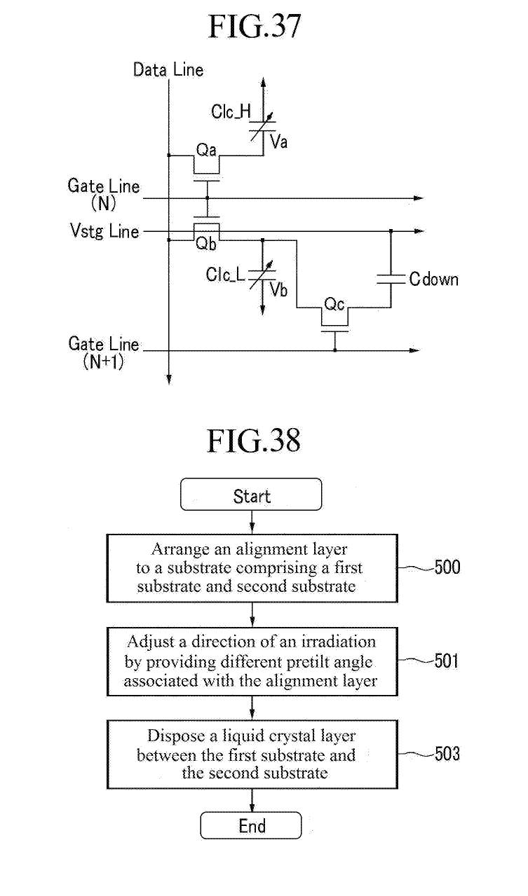

FIG. 36 and FIG. 37 are respectively a layout view and a circuit diagram showing a pixel to which the present invention may be applied. The present invention is applied to the vertical alignment (VA) mode liquid crystal display, and more preferably, to a pixel that is divided into a plurality of domains.

FIG. 36 is the layout view of the lower panel used in an exemplary embodiment of the present invention, and the structure of FIG. 36 will be schematically described.

One pixel includes two subpixels (the high gray subpixel and the low gray subpixel).

A plurality of first gate lines 121a and second gate lines 121b are formed on an insulation substrate made of transparent glass or plastic.

The first and second gate lines 121a and 121b transmit the gate signal. The first gate line 121a includes a plurality of first gate electrodes 124a and second gate electrodes 124b protruding upward, and the second gate line 121b includes a plurality of third gate electrodes 124c protruding upward.

A gate insulating layer (not shown) is formed on the first and second gate lines 121a and 121b. Semiconductors of an island type (not shown) are formed on the gate insulating layer. The semiconductors are positioned on the first, second, and third gate electrodes 124a, 124b, and 124c.

A plurality of data lines 171, a first source electrode 173a, a second source electrode 173b, a third source electrode 173c, a first drain electrode 175a, a second drain electrode 175b, a third drain electrode 175c, and an expansion 176 disposed at the end of the third drain electrode 175c are formed on the semiconductors and the gate insulating layer. The data line 171 transmits the data signal and mainly extends in the longitudinal direction thereby intersecting the first and second gate lines 121a and 121b.

The first gate electrode 124a, the first source electrode 173a, and the first drain electrode 175a form a first switching element, the second gate electrode 124b, the second source electrode 173b, and the second drain electrode 175b form a second switching element, and the third gate electrode 124c, the third source electrode 173c, and the third drain electrode 175c form a third switching element.

A passivation layer (not shown) is formed on the data line 171, the first source electrode 173a, the second source electrode 173b, and the third source electrode 173c, and the first drain electrode 175a, the second drain electrode 176a, and the third drain electrode 175c. The passivation layer has a first contact hole 181a exposing a portion of the first drain electrode 175a, a second contact hole 181b exposing a portion of the second drain electrode 175b, and a third contact hole 181c exposing a portion of the third drain electrode 175c.

A plurality of first subpixel electrodes (sub-pixel electrodes) 191a, second subpixel electrodes 191b, and third subpixel electrodes 191c that are made of a transparent electrode material are formed on the passivation layer. The first subpixel electrode 191a is connected to the first drain electrode 175a through the first contact hole 181a, the second subpixel electrode 191b is connected to the second drain electrode 175b through the second contact hole 181b, and the third subpixel electrode 191c is connected to the third drain electrode 175c through the third contact hole 181c.

The liquid crystal display according to exemplary embodiments of the present invention may further include a plurality of storage electrode lines 131 formed with the same layer as the first gate line 121a and the second gate line 121b. The storage electrode line 131 is applied with a predetermined voltage, and is separated from the first gate line 121a and the second gate line 121b and is parallel to them. The storage electrode line 131 is positioned between the first gate line 121a and the second gate line 121b. The storage electrode line 131 includes a storage electrode 133 expanded up or down, and an expansion 136 is formed at the end of the storage electrode 133.

If the first gate line 121a is applied with the gate-on voltage, the data voltage is applied to the first subpixel electrode and the second subpixel electrodes through the first switching element and the second switching element. Next, if the second gate line 121b is applied with the gate-on voltage, the voltage of the second subpixel electrode is changed according to the voltage of the second subpixel electrode and the capacitance of the expansions 136 and 176.

FIG. 37 is a circuit diagram of the structure applied with the present invention.

The circuit diagram of FIG. 37 may also be applied to the exemplary embodiment of FIG. 36, however the actual design may be different from FIG. 36.

The pixel of FIG. 37 includes a first switching element Qa and a second switching element Qb, a first liquid crystal capacitor Clc_H connected to the first switching element Qa, a second liquid crystal capacitor Clc_L connected to the second switching element Qb, a third switching element Qc connected to the second switching element Qb, and a storage capacitance capacitor Cdown connected to the third switching element Qc.

FIG. 38 is a flowchart of process for providing different pretilt angle associated an alignment layer for adjusting a direction of an irradiation according to exemplary embodiments of the present invention. As described, as in step 500, arranging an alignment layer to a substrate which comprises a first substrate and a second substrate. In step 501, adjusting a direction of an irradiation by providing different pretilt angle associated with the alignment layer. As in step 503, disposing a liquid crystal layer between the first substrate and the second substrate.

According to exemplary embodiments of the present invention, when the alignment layer aligns adjacent liquid crystal molecules while producing the pretilt, the present invention is contemplated that providing the different pretilt of the alignment layer of the upper substrate or the alignment layer of the lower substrate, or providing the different pretilt of the alignment layer of the high gray subpixel and the alignment layer of the low gray subpixel in one pixel, and as a result, the visibility is improved in the sides (the upper side or the right and left sides).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for manufacturing a liquid crystal display, comprising:
disposing a lower alignment layer on a lower substrate;
disposing an upper alignment layer on an upper substrate;
combining the upper substrate and the lower substrate, and inserting a liquid crystal layer therebetween,
wherein a first irradiation amount of which ultraviolet rays are irradiated to the lower alignment layer or the upper alignment layer in a first direction and a second irradiation amount of which ultraviolet rays are irradiated to the lower alignment layer or the upper alignment layer in a second direction perpendicular to the first direction are different.

2. The method of claim 1, wherein the alignment layer irradiated with ultraviolet rays in the first irradiation amount and the alignment layer irradiated with ultraviolet rays in the second irradiation amount are in the same alignment layer.

3. The method of claim 2, wherein:
the lower alignment layer and the upper alignment layer respectively comprise a first subpixel area and a second subpixel area;
ultraviolet rays are irradiated to the first subpixel area and the second subpixel area s together for the first irradiation amount; and
ultraviolet rays are irradiated for the second irradiation amount after one of the first subpixel area and the second subpixel area is covered.

4. The method of claim 1, wherein:
the first direction and the second direction are one of the long edge direction and the short edge direction of the lower substrate; and
the irradiation amount that is irradiated in a direction corresponding to the long edge direction is larger than the different irradiation amount.

5. The method of claim 1, wherein a visibility index of the liquid crystal display has a value of less than about 0.27 and more than about 0.235 by the magnitude difference of the first irradiation amount and the second irradiation amount.

6. A method comprising:
arranging an alignment layer corresponding to a substrate of a liquid crystal display, the substrate comprising a first substrate and a second substrate; and
disposing a liquid crystal layer between the first substrate and the second substrate, s wherein the alignment layer is configured to form a different pretilt angle associated with the alignment layer by adjusting a direction of an irradiation with respect to the first substrate and the second substrate.
